(19) United States
(12) Patent Application Publication
(10) Pub. No.: US 2025/0101602 A1
(43) Pub. Date: Mar. 27, 2025

(54) METHODS AND APPARATUS FOR CONVERTING METAL CARBONATE SALTS TO METAL HYDROXIDES

(71) Applicant: THE UNIVERSITY OF BRITISH COLUMBIA, Vancouver (CA)

(72) Inventors: Curtis BERLINGUETTE, Vancouver (CA); Zishuai ZHANG, Vancouver (CA); Benjamin MOWBRAY, Vancouver (CA)

(21) Appl. No.: 18/730,401

(22) PCT Filed: Jan. 20, 2023
(86) PCT No.: PCT/CA2023/050064

§ 371 Date: Jul. 19, 2024

Related U.S. Application Data
(60) Provisional application No. 63/301,189, filed on Jan. 20, 2022.

(51) Int. Cl. C25B 1/20; C25B 1/04; C25B 9/21; C25B 15/08

(52) U.S. Cl. CPC C25B 1/20; C25B 1/04; C25B 9/21; C25B 15/083

(57) ABSTRACT

Methods and apparatuses for converting metal carbonate salts to metal hydroxides are disclosed. The methods involve electrochemical production of hydrogen ions (H⁺) for decarbonating the metal carbonate salt to generate metal ions in a chemical compartment of the electrochemical cell. The metal ions are transported to a cathode compartment where they combine with hydroxide (OH⁻) to form metal hydroxides. The methods and apparatus may be applied to produce calcium hydroxide which may be used as a precursor for cement clinker. In some embodiments electrochemically produced hydrogen and oxygen are burned to produce heat for production of cement clinker.

### CROSS-REFERENCE TO RELATED APPLICATIONS

This application claims priority from U.S. application No. 63/301,189 filed 20 Jan. 2022 entitled CONVERSION OF CARBONATE SALTS TO HYDROXIDES IN AN ELECTROCHEMICAL FLOW REACTOR which is hereby incorporated herein by reference for all purposes. For purposes of the United States of America, this application claims the benefit under 35 U.S.C. § 119 of U.S. application No. 63/301,189 filed 20 Jan. 2022 entitled CONVERSION OF CARBONATE SALTS TO HYDROXIDES IN AN ELECTROCHEMICAL FLOW REACTOR which is hereby incorporated herein by reference for all purposes.

### FIELD

This invention relates generally to apparatuses and methods for converting metal carbonate salts to metal hydroxides. Specific embodiments provide electrochemical cells and methods which apply such cells for the electrolytic conversion of calcium carbonate to calcium hydroxide. The invention also provides methods and apparatus for production of cement clinker.

### BACKGROUND

Cement is an important building material. The production of cement clinker (a mixture of calcium silicates such as 3CaO·SiO₂₍ₛ₎) using conventional methods releases high carbon emissions. The high carbon intensity of cement clinker production is due to the calcination of limestone (CaCO₃₍ₛ₎) releasing CO_{2(g)} as a byproduct, and the combustion of fossil fuels to heat the high-temperature kilns and preheater cyclones that are required in the conventional methods.

There is a need for greener (higher energy efficiency and lower output of CO₂) methods and apparatus for producing cement clinker. The inventors have also recognised a general need for improved methods and apparatus for converting metal carbonate salt to metal hydroxides at high efficiency and low production costs and low carbon emission levels.

### SUMMARY

This invention has a number of aspects. These include, without limitation:
methods and apparatuses for producing cement clinker precursors;
methods and apparatuses for producing cement clinker;
methods and apparatuses for converting metal carbonate salts to metal hydroxides;
methods for converting metal carbonate salts to metal hydroxides at low applied potential (e.g., no more than 5 V and in some embodiments no more than 2V) with high current density (e.g., 100 mA cm⁻²);
methods and apparatuses for producing metal carbonate salts to metal hydroxides at low applied potential (e.g., about 5 V) with high current density (e.g., 100 mA cm⁻²) for a long electrolysis time (e.g., over 50 hours);
methods for generating pure gaseous byproducts of oxygen gas (O₂), carbon dioxide gas (CO₂) and/or hydrogen gas (H₂) in the conversion of metal carbonate salts to metal hydroxides.

An aspect of the invention relates to a method of producing metal hydroxide from metal carbonate salt in an electrochemical cell. The electrochemical cell comprises an anode chamber, a cathode chamber, a chemical compartment between the anode chamber and the cathode chamber, a first membrane separating the anode chamber and the chemical compartment, and a second membrane separating the cathode chamber and the chemical compartment.

The method comprises applying an electrical potential between an anode and a cathode of the electrochemical cell.

In some embodiments, the method comprises oxidizing a first hydrogen-containing reactant, at the anode, to form hydrogen ions. The hydrogen ions may permeate through a first membrane into the chemical compartment. The first membrane may be an ion exchange membrane, such as a cation exchange membrane. In some embodiments, the first hydrogen-containing reactant comprises hydrogen gas. In some embodiments, the reaction occurring at the anode to form hydrogen ions comprises a hydrogen oxidation reaction (HOR).

In some embodiments, the method comprises oxidizing a first hydrogen-containing reactant, at the anode, to form an intermediate molecule. The intermediate molecule may permeate into the first membrane to electrochemically dissociate into hydrogen ions and hydroxide ions. The first membrane may be a bipolar membrane. In some embodiments, the first hydrogen-containing reactant comprises an anolyte. The anolyte may for example be a base. The intermediate molecule may for example be water. In some embodiments, the reaction occurring at the anode to form hydrogen ions comprises an oxygen evolution reaction (OER).

In some embodiments, a metal carbonate salt is supplied to the chemical compartment. The metal carbonate salt reacts with the hydrogen ions and forms metal ions.

In some embodiments, the metal ions permeate through the second membrane into the cathode chamber.

In some embodiments, a second hydrogen-containing reactant is reduced at the cathode to form hydroxide ions. The second hydrogen-containing reactant may for example be water. In some embodiments, the reaction occurring at the cathode to comprises a hydrogen evolution reaction (HER). The metal ions may react with the hydroxide ions to form metal carbonate.

In some embodiments, instead of or in addition to producing hydroxide ions at the cathode, hydroxide ions are provided from an external source. The externally sourced hydroxide ions may be introduced into the cathode chamber.

In some embodiments, the electrical potential applied to the cell is has a magnitude that does not exceed 5 V, or does not exceed 2 V in some embodiments.

In some embodiments, the current density maintained in the electrolysis is at least 100 mA/cm⁻².

In some embodiments, hydrogen gas is produced as a byproduct in the cathode chamber. In some embodiments, carbon dioxide gas is produced as a byproduct in the chemical compartment. In some embodiments, oxygen gas is produced as a byproduct in the anode chamber.

In some embodiments, the anode comprises a gas diffusion electrode. The gas diffusion electrode may in some embodiments comprise a platinum catalyst supported on carbon (Pt/C).

In some embodiments, the anode and/or cathode comprises a free-standing layer of porous foam. The porous foam may for example comprise Nickel (Ni).

In some embodiments, the temperature of the electrolysis is maintained at less than about 60° C.

An aspect of the invention pertains to a method for producing calcium hydroxide from calcium carbonate. The method comprises supplying calcium carbonate (CaCO₃) to an electrochemical cell, applying an electrical potential of 5 Volts or less between an anode and a cathode of the electrochemical cell while maintaining an average current density of at least 100 mA cm⁻², at the cathode generating hydroxide ions (OH⁻), at the anode generating hydrogen ions (H⁺), in the electrochemical cell, dissociating carbon carbonate into calcium ions (Ca²⁺) and bringing the calcium ions together with the hydroxide ions, and removing the calcium hydroxide from the electrochemical cell.

An aspect of the invention pertains to a system for producing cement clinker products from calcium carbonate salt. The system comprises an electrochemical cell and a reactor arranged downstream of the electrochemical cell.

In some embodiments, the electrochemical cell comprises an anode arranged within an anode chamber, a cathode arranged within a cathode chamber, a chemical compartment between the anode chamber and the cathode chamber, a first ion exchange membrane between the anode chamber and the chemical compartment, a second ion exchange membrane between the cathode chamber and the chemical compartment, a power source configured to apply a positive electrical charge on the anode and a negative electrical charge on the cathode, an inlet at the chemical compartment arranged to receive a supply of a calcium carbonate salt (CaCO₃) into the chemical compartment for reaction with hydrogen ions (H⁺) produced at the anode to generate calcium ions, and an outlet at the cathode chamber arranged to discharge a flow of calcium hydroxide (Ca(OH)₂) produced from reacting calcium ions (Ca²⁺) with hydroxide ions (OH⁻) produced at the cathode.

In some embodiments, the electrochemical cell comprises an anode arranged within an anode chamber, a cathode arranged within a cathode chamber, a chemical compartment between the anode chamber and the cathode chamber, a bipolar membrane between the anode chamber and the chemical compartment, an ion exchange membrane between the cathode chamber and the chemical compartment, a power source configured to apply a positive electrical charge on the anode and a negative electrical charge on the cathode, an inlet at the chemical compartment arranged to receive a supply of a calcium carbonate salt (CaCO₃) into the chemical compartment for reaction with hydrogen ions (H⁺) diffused from the bipolar membrane to generate calcium ions, and an outlet at the cathode chamber arranged to discharge a flow of calcium hydroxide (Ca(OH)₂) produced from reacting calcium ions (Ca²⁺) with hydroxide ions (OH⁻) produced at the cathode;

In some embodiments, the reactor contains silicon dioxide (SiO₂) and is configured to receive the flow of calcium hydroxide and to contact with the silicon dioxide so that the calcium hydroxide reacts with the silicon dioxide to yield a cement clinker product.

In some embodiments, the system further comprises a dryer arranged downstream of the electrochemical cell and upstream of the reactor, connected to receive the flow of calcium hydroxide and configured to dry the calcium hydroxide before entering the reactor.

In some embodiments, the system further comprises a second electrochemical cell connected to receive carbon dioxide gas produced in the chemical compartment of the electrochemical cell into a cathode of the second electrochemical cell, the second electrochemical cell configured to reduce carbon dioxide gas into one or more carbon-containing compounds.

In some embodiments, the system further comprises a first outlet for discharging oxygen gas (O₂) produced at the anode, a second outlet for discharging hydrogen gas (H₂) produced at the cathode, a combustion chamber arranged downstream of the electrochemical cell, the combustion chamber connected to receive oxygen gas discharging through the first outlet and hydrogen gas discharging through the second outlet, and configured to react the oxygen gas with the hydrogen gas to release heat, and a heat transfer conduit arranged to transfer the released heat to the reactor to drive the reaction of the calcium hydroxide and the silicon dioxide.

An aspect of the invention relates to a system for producing metal hydroxide from metal carbonate salt. The system comprises an electrochemical cell and a chemical reactor arranged downstream of the electrochemical cell.

In some embodiments, the electrochemical cell comprises an anode arranged within an anode chamber, a cathode arranged within a cathode chamber, a chemical compartment between the anode chamber and the cathode chamber, a first ion exchange membrane between the anode chamber and the chemical compartment, a second ion exchange membrane between the cathode chamber and the chemical compartment, a power source configured to apply a positive electrical charge on the anode and a negative electrical charge on the cathode, at least one inlet at the chemical compartment arranged to receive a supply of a metal carbonate salt into the chemical compartment for reaction with hydrogen ions (H⁺) produced at the anode to generate metal ions, and to receive a supply of a solvent comprising a cation and an anion, wherein the cations are caused to permeate through the second ion exchange membrane into the cathode chamber to react with hydroxide ions contained in the cathode chamber to generate an intermediate hydroxide, and wherein the anions are caused to react with the metal ions to generate a salt, an outlet at the chemical compartment arranged to discharge a flow of the salt, and an outlet at the cathode chamber arranged to discharge a flow of the intermediate hydroxide.

In some embodiments, the electrochemical cell comprises an anode arranged within an anode chamber, a cathode arranged within a cathode chamber, a chemical compartment between the anode chamber and the cathode chamber, a bipolar membrane between the anode chamber and the chemical compartment, a second ion exchange membrane between the cathode chamber and the chemical compartment, a power source configured to apply a positive electrical charge on the anode and a negative electrical charge on the cathode, at least one inlet at the chemical compartment arranged to receive a supply of a metal carbonate salt into the chemical compartment for reaction with hydrogen ions (H⁺) produced at the bipolar membrane to generate metal ions, and to receive a supply of a solvent comprising a cation and an anion, wherein the cations are caused to permeate through the second ion exchange membrane into the cathode chamber to react with hydroxide ions contained in the cathode chamber to generate an intermediate hydroxide, and wherein the anions are caused to react with the metal ions to generate a salt, an outlet at the chemical compartment arranged to discharge a flow of the salt, and an outlet at the cathode chamber arranged to discharge a flow of the intermediate hydroxide.

In some embodiments, the chemical reactor is configured to receive the flow of the salt and the flow of the intermediate hydroxide so that the metal ions contained in the salt and the hydroxide ions contained in the intermediate hydroxide react to yield metal hydroxides.

In some embodiments, the second ion exchange membrane is selectively permeable to alkali metal ions. The second ion exchange membrane may be adapted to block passage of alkaline earth metal ions.

In some embodiments, the solvent comprises an alkali cation. In some example embodiments, the solvent comprises potassium chloride.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1A is a schematic diagram of an electrochemical cell showing electrochemical and chemical reactions that may occur in each of the reaction zones of the cell according to an example embodiment.

FIG. 1B is a schematic diagram of an electrochemical cell showing electrochemical and chemical reactions that may occur in each of the reaction zones of the cell according to another example embodiment.

FIG. 1C is a schematic diagram of an electrochemical cell and a chemical reactor arranged downstream of the electrochemical cell configured to produce metal hydroxides in tandem according to another example embodiment.

FIG. 1D is a schematic diagram of the electrochemical cell and chemical reactors of FIG. 1C, showing the electrochemical and chemical reactions that may occur in each of the reaction zones of the cell according to an example embodiment.

FIG. 2 is a block diagram illustrating the FIG. 1A electrochemical cell including ancillary equipment according to an example embodiment of the invention.

FIG. 3 is an exploded view of a reactor according to an example embodiment of the invention.

FIG. 4A is a flow chart showing the steps of a method for converting metal carbonate salts to hydroxides using the FIG. 1A and FIG. 1B electrochemical cells according to an example embodiment of the invention.

FIG. 4B is a continuation of the FIG. 4A flow chart showing the steps of a method for converting metal carbonate salts to hydroxides using the FIG. 1A and FIG. 1B electrochemical cells according to an example embodiment of the invention.

FIG. 5 is a graph comparing the voltage drop across each component for both a HOR (hydrogen oxidation reaction) electrolyzer and an OER (oxygen evolution reaction) electrolyzer during the production of Ca(OH)₂.

FIG. 6A is a plot of the cell voltage (V_{cell}) as a function of current density j (mA cm⁻²) comparing the cell voltages required to convert calcium carbonate to calcium hydroxide using the HOR electrolyzer and the OER electrolyzer.

FIG. 6B is a plot of current efficiency (%) as a function of time (h) comparing the current efficiencies of the OER and HOR electrolyzers over five hours of electrolysis.

FIG. 7 is a Fourier-transform infrared spectroscopy (FTIR) spectrum for the solid reaction product generated in the cathode compartment after an electrolysis experiment.

FIG. 8A is a schematic diagram of an OER electrolyzer showing the reference electrode placement for three-electrode voltage measurement.

FIG. 8B is a schematic diagram of a HOR electrolyzer showing the reference electrode placement for three-electrode voltage measurement.

FIG. 9A is a schematic diagram illustrating a pathway for electrochemical cement production using a HOR electrolyzer to generate clinker precursors.

FIG. 9B is a schematic diagram illustrating a pathway for electrochemical cement production using an OER electrolyzer to generate clinker precursors.

FIG. 10A is a graph illustrating a single parameter sensitivity analysis of the emissions intensity of Portland cement manufacturing using a HOR cement electrolyser to generate Ca(OH)₂.

FIG. 10B is a graph illustrating a single parameter sensitivity analysis of the emissions intensity of Portland cement manufacturing using a OER cement electrolyser to generate Ca(OH)₂.

FIG. 10C is a graph illustrating a single parameter sensitivity analysis of the breakeven production cost of Portland cement manufacturing using a HOR cement electrolyser to generate Ca(OH)₂.

FIG. 10D is a graph illustrating a single parameter sensitivity analysis of the breakeven production cost of Portland cement manufacturing using a OER cement electrolyser to generate Ca(OH)₂.

FIG. 11A is a graph showing CO₂ emissions intensities for electrochemical cement production with HOR and OER electrolyzers calculated to represent current market conditions ($0.05/kWh, 0.15 kg CO₂/kWh).

FIG. 11B is a graph showing CO₂ emissions intensities for electrochemical cement production with HOR and OER electrolyzers calculated to represent an optimistic scenario with inexpensive solar electricity ($0.02/kWh, 0.04 kg CO₂/kWh).

FIG. 12A is a graph illustrating production cost for electrochemical cement production with HOR or OER electrolysers, in which the production cost is calculated based on current market conditions ($0.05/kWh, 0.15 kg CO₂/kWh, $50/tCO₂).

FIG. 12B is a graph illustrating production cost for electrochemical cement production with HOR or OER electrolysers, in which the production cost is calculated based on an optimistic scenario with inexpensive solar electricity and progressive carbon pricing ($0.02/kWh, 0.04 kg CO₂/kWh, $85/tCO₂).

FIG. 13A is an SEM image of CaCO₃ particles before electrolysis.

FIG. 13B is an SEM image of CaCO₃₍ₛ₎ particles after electrolysis at 45 mA cm⁻² using an OER electrolyser.

FIG. 14 is a plot of CaCO₃₍ₛ₎ size (μm) as measured by dynamic light scattering (DLS) techniques as a function of time (min) during electrolysis at 45 mA cm⁻² using an OER electrolyzer.

FIG. 15 is a plot of CO₂ formation rate [i-CO_{2(g)}] as a function of time (h) during electrolysis for 5 hours at 45 mA cm⁻² using a OER electrolyzer.

FIG. 16 is a Fourier-transform infrared spectroscopy (FTIR) spectrum of the produced Ca(OH)₂ collected after electrolysis at 45 mA cm⁻² using an OER electrolyzer.

FIG. 17 is a X Ray Diffraction (XFD) pattern of Ca(OH)₂₍ₛ₎ precipitate collected from the cathode compartment after 5 hours of electrolysis at 45 mA cm⁻² using an OER electrolyzer.

FIG. 18 is a plot of total Ca(OH)₂ mass (mg) as a function of time (h), showing the production rate of Ca(OH)₂₍ₛ₎ during electrolysis at 45 mA cm⁻² using an OER electrolyzer.

FIG. 19A is a scanning electron microscopy image of a nickel foam cathode before electrolysis.

FIG. 19B is a scanning electron microscopy image of the nickel foam cathode of FIG. 19A after electrolysis for 5 hours at 45 mA cm⁻² in an OER electrolyzer.

FIG. 20 is a plot of cell voltage (V_{cell}) as a function of electrolysis time (h) at 100 mA cm⁻².

FIG. 21 is a plot of cell voltage (V_{cell}) as a function of current density (J mA cm⁻²).

FIG. 22 is a schematic diagram illustrating an OER electrolyzer coupled to a downstream CO₂RR electrolyzer for reducing CO_{2(g)} released during CaCO₃₍ₛ₎ decomposition according to an example embodiment.

FIG. 23 is a plot of CO_{2(g)} utilization and Faradaic efficiency for CO_{(g)} (FE_{CO}) against current density j _{CO2RR} (mA cm⁻²) for the CO₂RR electrolyzer operated at 10, 20 and 30 mA cm⁻². The OER electrolyzer was operated at a constant current density of 90 mA cm⁻².

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Definitions

“Bipolar membrane” or “BPM” is a membrane comprising plural layers including an anion exchange layer on one side and a cation exchange layer on another side. A bipolar membrane may comprise one or more layers between the anion exchange layer and the cation exchange layer. For example, an intermediate layer may comprise a catalyst which facilitates dissociation of water into protons and hydroxide ions. The anion exchange layer may conduct hydroxide ions. The cation exchange layer may conduct protons. An example bipolar membrane is Fumasep FBM™ available from FUMATECH BWT GmbH.

“Cation exchange membrane” or “CEM” is a membrane that is selectively permeable to cations. An example cation exchange membrane is Nafion™.

“Membrane electrode assembly” or “MEA” is an assembly comprising an anode and/or a cathode separated by one or more ion exchange membrane. The anode and the cathode may respectively comprise catalysts suitable for promoting oxidation reactions at the anode and reduction reactions at the cathode.

“Flow cell” refers to an electrochemical cell in which a catholyte and/or anolyte are flowed through the cell while the cell is in operation. A non-limiting example construction of a flow cell provides flow plates separated by an MEA. An anode flow plate is located at the anode side of the MEA and a cathode flow plate is located at the cathode side of the MEA. The anode and cathode flow plates comprise flow channels that respectively receive an anode feed and a cathode feed. A power supply is connected across the anode and cathode of the MEA in the flow cell to drive oxidation reactions at the anode and reduction reactions at the cathode.

“Current density” is total current divided by the geometric surface area of an electrode. For example, an electrode having an area of 100 cm² carrying an electrical current of 20 Amperes would have a current density of 200 mA/cm².

“Faradaic efficiency” (F.E.) is a measure of the efficiency with which an electron transfer reaction generates a desired product. Faradaic efficiency can be reduced by side reactions which create undesired products or by further reactions which consume the desired product after it is produced. F.E. for a gaseous product k may be determined in accordance with Equation 1.

$$FE = \frac{{n}_{k} {Fx}_{k} {F}_{m}}{I} \qquad ( Eq . 1 )$$

where nₖ is the number of electrons exchanged, F is Faraday's constant (F=96,485 C/mol), xₖ is the mole fraction of the gas k in the gaseous mixture analyzed, Fₘ is the molar flow rate in mol/s, and/is the total current in A. The molar flow rate may be derived from the volume flow rate Fᵥ by the relation Fₘ=pFᵥ/RT, with p being the atmospheric pressure in Pa, R the ideal gas constant of 8.314 J/mol K and T the temperature in Kelvin.

Ion exchange membrane is a membrane that has a significantly higher permeability for certain dissolved ions than for other ions. Ideally an ion exchange membrane would pass ions of a selected species or type (e.g. cations or anions) while blocking other ions and neutral molecules. A CEM is an example of an ion exchange membrane.

“Oxygen evolution reaction” or “OER” is the process of generating molecular oxygen by an electrochemical reaction. An example of an oxygen evolution reaction is the oxidation of hydroxide, in accordance with Equation 2.

4OH⁻_{(aq)}-4e⁻→2H₂O₍ₗ₎+O_{2(g)} (Eq. 2)

“Hydrogen oxidation reaction” or “HOR” is an electrochemical reaction that involves the oxidation of hydrogen molecules. The reaction products depend on the environment in which the reaction occurs. The environment may be acidic or alkaline. An example of an hydrogen oxidation reaction is the oxidation of hydrogen gas, in accordance with Equation 3.

H_{2(g)}→2H⁺_{(aq)}+2e⁻ (Eq. 3)

“Hydrogen evolution reaction” or “HER” is the process of producing hydrogen by an electrochemical process. An example of a hydrogen evolution reaction is the reduction of water, in accordance with Equation 4.

H₂O₍ₗ₎+2e→H_{2(g)}+2OH⁻_{(aq)} (Eq. 4)

### EXAMPLE EMBODIMENTS

Aspects of the invention relate to particularly efficient methods of converting metal carbonate salt to metal hydroxides. Such methods may be performed in a way that produces separate streams of gaseous byproducts. Examples of gaseous byproducts generated by such methods include one or more of carbon dioxide (CO₂), hydrogen gas (H₂) and oxygen gas (O₂). These methods may, for example, be applied to convert calcium carbonate to calcium hydroxide. In some embodiments the calcium hydroxide is used as a precursor for the production of cement clinkers.

The particularly efficient methods involve operating an electrochemical cell to cause paired electrochemical reactions. An oxidation reaction occurs at an anode of the electrochemical cell. A reduction reaction occurs at a cathode of the electrochemical cell. In some example embodiments, the oxidation reaction serves as a source of hydrogen ions (H⁺) for decarbonating the metal carbonate salt to generate metal ions in a chemical compartment of the electrochemical cell. In some example embodiments the reduction reaction serves as a source of hydroxides (OH⁻) for chemical reaction with the metal ions to form metal hydroxides in a cathode compartment of the electrochemical cell.

In some embodiments, the oxidation reaction at the anode is a hydrogen oxidation reaction (HOR) and the reduction reaction at the cathode is a hydrogen evolution reaction (HER).

In some embodiments, the oxidation reaction at the anode is an oxygen evolution reaction (OER). In some embodiments the reduction reaction at the cathode is a hydrogen evolution reaction (HER).

As mentioned above, these electrochemical methods may be applied in the field of cement manufacturing. Such electrochemical methods may be applied to efficiently produce calcium hydroxide (Ca(OH)₂₍ₛ₎ from calcium carbonate (CaCO₃₍ₛ₎. Calcium hydroxide may for example be used directly such as in geopolymer cements, or participate in further reactions to generate calcium silicate species that are common to cement clinker.

Proof of concept demonstrations of the methods of converting calcium carbonates to calcium hydroxide using electrochemical cells as described herein have shown that current densities of about 100 mA cm⁻² with an applied electrical potential of less than about 5 V (in some embodiments, less than about 2 V) can be achieved.

### Overview of Apparatus and Methods for Converting Metal Carbonate Salt to Hydroxides

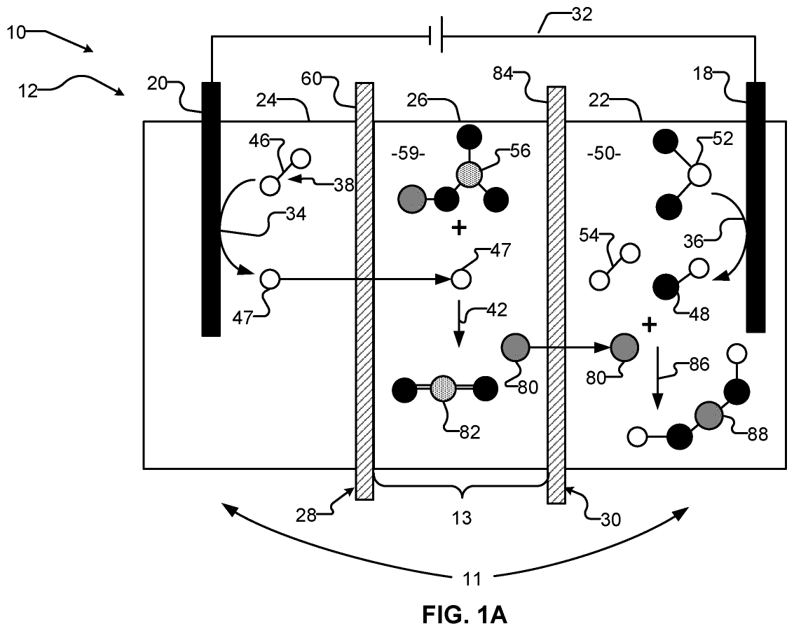

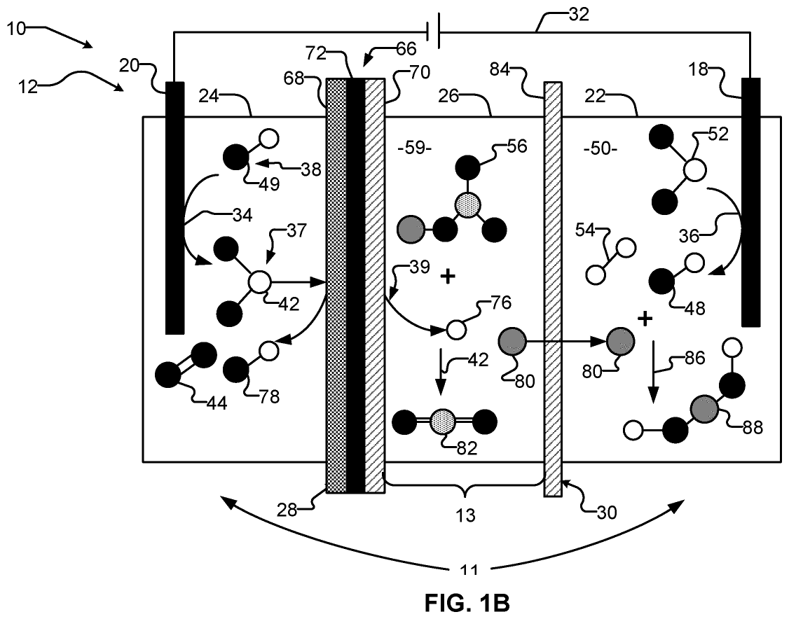

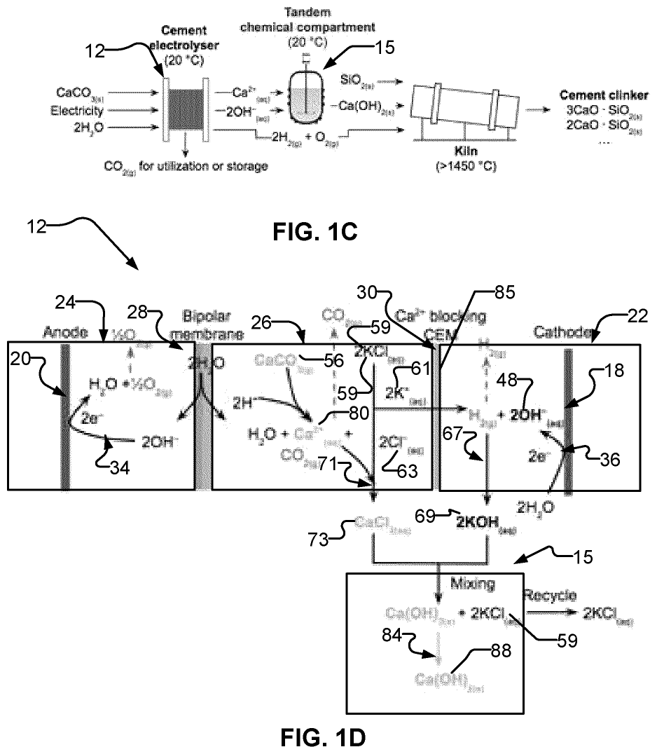

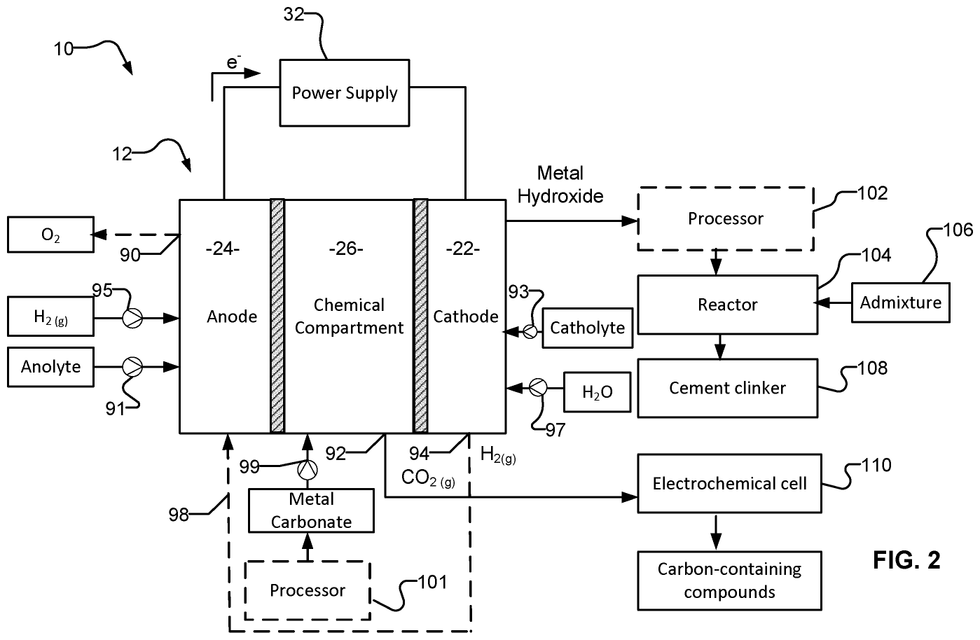

FIGS. 1A, 1B and 2 are schematic diagrams that illustrate example systems 10 that include an electrochemical cell 12 for converting metal carbonate salts to metal hydroxides.

Cell 12 comprises an electrochemical zone 11 and a chemical zone 13. One or more electrochemical reactions occur in electrochemical zone 11. One or more chemical reactions occur in electrochemical zone 11 and chemical zone 13.

Electrochemical zone 11 comprises a cathode chamber 22 and an anode chamber 24. A cathode 18 is exposed to cathode chamber 22. An anode 20 is exposed to anode chamber 24. Chemical zone 13 comprises a chemical compartment 26. Chemical compartment 26 separates cathode chamber 22 and anode chamber 24. A first membrane 28 separates anode chamber 24 and chemical compartment 26. A second membrane 30 separates cathode chamber 22 and chemical compartment 26.

A power source 32 is connected to apply an electrical potential difference between cathode 18 and anode 20. A negative electrical charge is applied to the cathode. A positive electrical charge is applied to the anode. A first electrochemical reaction 34 takes place at anode 20.

First electrochemical reaction 34 may be an oxidation reaction. A second electrochemical reaction 36 takes place at cathode 18. Second electrochemical reaction 36 may be a reduction reaction.

Power source 32 may be configured to maintain a desired electric current between cathode 18 and anode 20 and/or to maintain a potential difference between cathode 18 and anode 20 at a desired level or in a desired range.

Cathode 18 may comprise any materials suitable for use as an electrode. Such material may, for example comprise a catalyst suitable for driving a hydrogen evolution reaction (HER).

Anode 20 may comprise any materials suitable for use as an electrode. Such material may comprise a catalyst suitable for driving a hydrogen oxidation reaction (HOR) and/or an oxygen evolution reaction (OER).

Cathode 18 and/or anode 20 may be a gas diffusion electrode.

Cathode 18 and/or anode 20 may be made of one or more metal, alloy or a supported metal/alloy catalyst. The metal may be any transition metal, or combination of one or more transition metals. Suitable electrocatalyst that may be incorporated in cathode 18 may, for example, comprise one or more of C, Pt, Fe, Co, Mo, and combinations thereof. Suitable electrocatalyst that may be incorporated in anode 20 may, for example, comprise one or more of Pt, Rh, Ir, Ru, Pd, Ni, and combinations thereof.

Cathode 18 and/or anode 20 may be porous. An example of a porous electrode is an electrode comprising an electrically conductive foam such as a metal foam. In some example embodiments, cathode 18 and/or anode 20 comprises a layer of porous nickel (Ni) foam. The nickel foam layer may be free-standing or supported (e.g. by other components of a membrane electrode assembly).

In some embodiments, the porosity of the foam electrode is about 50% to about 90%. In one example embodiment, the porosity of the foam electrode is about 80%. In some embodiments, the foam electrode has a thickness in the range of from about 200 to about 300 μm.

A first hydrogen-containing reactant 38 is supplied to anode chamber 24. In some embodiments, first hydrogen-containing reactant 38 participates in first electrochemical reaction 34 to generate hydrogen ions. In some embodiments, first hydrogen-containing reactant 38 participates in first electrochemical reaction 34 to generate an intermediate molecule 37. Intermediate molecule 37 participates in a further electrochemical reaction 39 to generate hydrogen ions.

In some embodiments, first hydrogen-containing reactant 38 comprises a gas. In some example embodiments, first hydrogen-containing reactant 38 comprises hydrogen gas (H₂) 46. In such example embodiments, hydrogen gas 46 participates in first electrochemical reaction 34 at anode 20 to generate hydrogen ions 47. In such embodiments anode 20 is in contact with membrane 28 to facilitate transfer of produced hydrogen ions 47 into chemical compartment 26.

In some embodiments, first electrochemical reaction 34 comprises a hydrogen oxidation reaction (HOR). First electrochemical reaction 34 may however comprise another reaction which produces hydrogen ions 47.

In some embodiments, first hydrogen-containing reactant 38 is any solvent suitable for use as an anolyte. First hydrogen-containing reactant 38 may comprise a base. In some example embodiments, first hydrogen-containing reactant 38 comprises a solution containing hydroxide ions (OH⁻) 49. Hydroxide ions 49 may participate in first electrochemical reaction 34 at anode 20 to generate water molecules 42 and oxygen gas (O₂) 44. In such embodiments, water molecules 42 can serve as intermediate molecules 37 which participate in further electrochemical reaction 39 to generate hydrogen ions.

In some embodiments, first electrochemical reaction 34 comprises an oxygen evolution reaction (OER). In some embodiments, further electrochemical reaction 39 comprises electrochemical dissociation of water molecules. First electrochemical reaction 34 and/or further electrochemical reaction 39 may however comprise other reactions which produce hydrogen ions.

A suitable catholyte 50 is supplied to cathode chamber 22. A suitable catholyte 50 facilitates second electrochemical reaction 36 by providing second hydrogen-containing reactant 52 which can receive electrons from cathode 18 to yield hydroxide ions (OH⁻). A suitable catholyte 50 may be an acid. Non-limiting examples of suitable catholyte 50 include H₂SO₄, KCl, and H₃PO₄.

In some embodiments, second hydrogen-containing reactant 52 comprises water (H₂O). In such embodiments, the electrochemical dissociation of water at cathode 18 yields hydrogen gas 54 and hydroxide ions 48. In some embodiments, second electrochemical reaction 36 comprises a hydrogen evolution reaction (HER). Second electrochemical reaction 36 may comprise any other reaction which produces hydroxide ions (OH⁻).

In some embodiments, instead of or in addition to producing hydroxide ions by second electrochemical reaction 36, hydroxide ions are provided from an external source. The externally sourced hydroxide ions may, for example, be introduced into cathode chamber 22 and/or supplied to an external reactor in which the hydroxide ions are introduced to metal ions (e.g. calcium ions) from electrochemical cell 12. In some example embodiments, second electrochemical reaction 36 comprises a reduction reaction which does not produce hydroxide ions (OH⁻). In some embodiments, any suitable species such as a metal or oxygen gas that can participate in a reduction reaction can be used as second hydrogen-containing reactant 52. The reduction of second hydrogen-containing reactant 52 in such embodiments facilitates the oxidation reaction which occurs at anode 20. Non-limiting examples of second hydrogen-containing reactant 52 include metal (e.g., copper) or oxygen gas. In some such embodiments, an external supply of hydroxide ions is supplied to cathode chamber 22.

A metal carbonate salt 56 is supplied to chemical compartment 26. Metal carbonate salt 56 may comprise ions of any suitable metals, for example alkali metals, alkaline earth metals, transition metals, lanthanides, and actinides. In some embodiments, metal carbonate salt 56 comprises an alkaline earth metal carbonate salt such as CaCO₃, SrCO₃ or BaCO₃.

In some embodiments, a mixture 58 comprising metal carbonate salt 56 is supplied to chemical compartment 26. Mixture 58 may comprise metal carbonate salt 56 and a suitable solvent 59. In other embodiments, solvent 59 is supplied to chemical compartment 26 separate from metal carbonate salt 56. In some embodiments the metal carbonate salt is provided to chemical compartment 26 as solid particles in a slurry.

A suitable solvent 59 may increase the electrical conductivity of the solution in chemical compartment 26. Any solvent 59 which does not interfere with the reactions occurring with chemical compartment 26 may be used. In one example embodiment, solvent 59 comprises calcium chloride solution. In some embodiments, solvent 59 is supplied to chemical compartment 26 at the start of the electrolysis for a specified time period. Such specified time period may for example be t=0 (i.e., start of the electrolysis) to about t=1 hour, or any time interval between t=0 and t=1 hour. Metal carbonate salt 56 may be supplied to chemical compartment 26 without solvent 59 after the specified time period.

In some embodiments, first membrane 28 is a first ion exchange membrane 60.

In some embodiments, first ion exchange membrane 60 is selectively permeable to hydrogen ions 47, 76. Hydrogen ions 47, 76 are generated from first electrochemical reaction 34 at anode 20. Hydrogen ions 47, 76 may permeate through ion exchange membrane 60 into chemical compartment 26. Hydrogen ions 47, 76 may participate in a first chemical reaction 42 with metal carbonate 56 to form metal ions 80 and carbon dioxide 82. In some embodiments, first ion exchange membrane 60 is a cation exchange membrane (CEM).

In some embodiments, as illustrated in FIG. 1B, first membrane 28 is a bipolar membrane (BPM) 66. Bipolar membrane 66 comprises an anion exchange layer 68, a cation exchange layer 70, and an intermediate layer 72 separating layers 68, 70. Anion exchange layer 68 faces anode chamber 24. Cation exchange layer 70 faces chemical compartment 26. Water molecules 42 may diffuse into or be supplied into intermediate layer 72. In some embodiments, water molecules 42 include intermediate molecules 37 formed from first electrochemical reaction 34 occurring at anode 20. Bipolar membrane 66 is adapted to perform further electrochemical reaction 39. Bipolar membrane is adapted (e.g. by provision of a suitable catalyst in intermediate layer 72) to dissociate water molecules 42 into hydroxide ions 78 and hydrogen ions 76.

Hydroxide ions 78 may permeate through anion exchange layer 68 into anode chamber 24. Hydrogen ions 76 may permeate through cation exchange layer 70 into chemical compartment 26. Hydrogen ions 76 may participate in a first chemical reaction 42 with carbonate ions from metal carbonate salt 56. Metal carbonate salt 56 may decompose into metal ions 80 and carbon dioxide (CO₂) 82. Hydrogen ions 76 may react with carbonate ions from metal carbonate salt 56 in accordance with Equation 4:

2H⁺+CO₃²⁻ [symbol] H₂O+CO₂ (Eq. 4)

In some embodiments, second membrane 30 is a second ion exchange membrane 84. Second ion exchange membrane 84 may be selectively permeable to metal ions 80. Metal ions 80 may permeate through second ion exchange membrane 84 into cathode chamber 22. Metal ions 84 may participate in a second chemical reaction 86 by reacting with hydroxide ions 48 (which may, for example be a product of second electrochemical reaction 36 occurring at cathode 18 or an externally source of hydroxide ions such as a solution comprising hydroxide ions) to generate metal hydroxides 88. In some embodiments metal hydroxides 88 are of low solubility in catholyte 50 and precipitate as a solid.

In an example embodiment, metal carbonate salt 56 comprises calcium carbonate. Calcium carbonate is suspended in calcium chloride solution to form mixture 58. Mixture 58 comprising the calcium carbonate is supplied into chemical compartment 26. In some embodiments, hydrogen ions 47 are generated directly from first electrochemical reaction 34 at anode 20. In some embodiments, hydrogen ions 76 are generated first electrochemical reaction 34 followed by further electrochemical reaction 39 in bipolar membrane 66. Hydrogen ions 47, 76 permeate through first membrane 28 from anode chamber 24 to chemical compartment 26. Hydrogen ions 47, 76 react with calcium carbonate in the chemical compartment to generate calcium ions and carbon dioxide gas, in accordance with Equation 5:

CaCO₃₍ₛ₎+2H⁺_{(aq)} [symbol] Ca²⁺_{(aq)}+CO_{2(g)}+H₂O (Eq. 5)

Calcium ions permeate through second membrane 30 into cathode chamber 22. Hydroxide ions 48 are generated from second electrochemical reaction 36 at cathode 18. Calcium ions react with hydroxide ions 48 in cathode chamber 22 to form calcium hydroxide, in accordance with Equation 6:

Ca²⁺_{(aq)}+2OH⁻_{(aq)} [symbol] Ca(OH)₂₍ₛ₎ (Eq. 6)

In some embodiments of the invention, metal hydroxides 88 are produced outside of cell 12. The production of metal hydroxides outside of the electrochemical cell may eliminate or reduce accumulation of solid precipitate produced in the cell. Accumulation of solid precipitate in the cell, or specifically, on second membrane 30 and/or cathode 18 may undesirably affect the operation and/or efficiency of the electrolysis. The production of metal hydroxides outside of the electrochemical cell using example embodiments of the invention may allow for producing metal hydroxides at a low applied potential (e.g., with a stable cell voltage of about 5 V) with high current density (e.g., 100 mA cm⁻²) for a long electrolysis time (e.g., over about 50 hours).

Referring to FIG. 1C, a chemical reactor 15 may be arranged downstream of cell 12. Chemical reactor 15 may be arranged to receive one or more products from cell 12. Chemical reactor 15 may be operated in tandem with cell 12 to produce metal hydroxides 88. In such embodiments, second chemical reaction 84 occurs in chemical reactor 15.

Referring to FIG. 1D, second membrane 30 comprises a second ion exchange membrane 85. Second ion exchange membrane 85 may be selectively permeable to certain ions. In some embodiments, second ion exchange membrane 85 is selectively permeable to type 1 metal ions or alkali metal ions such as hydrogen (H), lithium (Li), sodium (Na), potassium (K), rubidium (Rb), cesium (Cs), and francium (Fr). In some embodiments, second ion exchange membrane 85 is adapted to block ions with sizes greater than alkali metal ions.

In some embodiments, second ion exchange membrane 85 comprises a composite membrane prepared from a membrane commercially available under the trade name Nafion™. In some embodiments, second ion exchange membrane 85 comprises protonated polyaniline (PANI) polymerized on opposing sides of a Nafion membrane.

In some embodiments, second ion exchange membrane 85 is an unmodified Nafion™ membrane. In some embodiments, solvent 59 comprises a solution having metal ions which are different from the metal ions contained in the metal carbonate 56 and second ion exchange membrane 85 is permeable to those metal ions so that the metal ions can act to carry current to cathode 18. Ion exchange membrane 85 may block the metal ions contained in metal carbonate 56 such that those metal ions remain in the flow of solvent exiting chemical compartment 26 and may be carried to a separate downstream reactor where the metal ions may be introduced to hydroxide ions to form a metal hydroxide.

For example, in embodiments in which metal carbonate 56 comprises calcium carbonate, solvent 59 may comprise metal ions that are not calcium ions. In some example embodiments, solvent 59 comprises a solution containing alkali metal ions. In one example embodiment, solvent 59 comprises potassium chloride.

In solution, solvent 59 may be adapted to dissociate in chemical compartment 26 to form cations 61 and anions 63.

In some embodiments, cations 61 are caused to permeate through second ion exchange membrane 85 into cathode chamber 22. Cations 61 may be caused to participate in a third chemical reaction 67 to react with hydroxide ions 48 (which may for example be generated from second electrochemical reaction 36 at cathode 18) to form an intermediate hydroxide 69. Intermediate hydroxide 69 may be removed from cathode chamber 22. Intermediate hydroxide 69 may be supplied to chemical reactor 15.

In some embodiments, anions 63 are caused to participate in a fourth chemical reaction 71 in chemical compartment 26 for reaction with metal ions 80 dissociated from metal carbonate 56 to form a salt 73. Salt 73 may be removed from chemical compartment 26. Salt 73 may be supplied to chemical reactor 15.

The hydroxide ions 48 contained in intermediate hydroxide 69 may participate in second chemical reaction 84 by reacting with metal ions 80 contained in salt 73 to form metal hydroxides 88. Solvent 59 comprising cations 61 and anions 63 may be formed in second chemical reaction 84.

Metal hydroxides 88 may be removed from chemical reactor 15.

Regenerated solvent 59 formed in second chemical reaction 84 may be recycled to chemical compartment 26 of cell 12 for re-use in subsequent reactions occurring in chemical compartment 26.

In an example embodiment, metal carbonate salt comprises calcium carbonate. Calcium carbonate may be suspended in potassium chloride (KCl) solution to form a mixture. The mixture may be supplied into chemical compartment 26. Potassium chloride solution may alternatively be supplied to chemical compartment 26 separately from calcium carbonate.

In some embodiments, hydrogen ions are generated directly from a first electrochemical reaction at anode 20. In some embodiments, hydrogen ions are generated from first electrochemical reaction 34 followed by further electrochemical reaction 39 in bipolar membrane 66. Hydrogen ions permeate through first membrane 28 from anode chamber 24 into chemical compartment 26. Hydrogen ions react with calcium carbonate in chemical compartment 26 to generate calcium ions and carbon dioxide gas.

In solution, potassium chloride (KCl) dissociates in chemical compartment 26 to form potassium ions and chloride ions.

Potassium ions (K⁺) may permeate through second membrane 30 into cathode chamber 22. Potassium ions may participate in third chemical reaction 67 to react with hydroxide ions (which may for example be produced from a reduction reaction at cathode 18) to form potassium hydroxide. Potassium hydroxide may be the intermediate hydroxide 69. Potassium hydroxide may be removed from cell 12 and supplied to chemical reactor 15.

Chloride ions (Cl⁻) may participate in fourth chemical reaction 71 to react with calcium ions to form calcium chloride salt. Calcium chloride salt may be removed from chemical compartment 26 and supplied to chemical reactor 15.

Calcium ions contained in calcium chloride salt may participate in second chemical reaction 84 with hydroxide ions contained in potassium hydroxide to form calcium hydroxide.

In some embodiments, a first outlet 90 is arranged at anode chamber 24 for output of gas formed and/or unused from reactions occurring in anode chamber 24. In some embodiments, oxygen gas 44 is generated from first electrochemical reaction 34. The oxygen gas 44 may flow out of anode chamber 24 through first outlet 90. In some embodiments a stream of pure oxygen gas is collected from anode chamber 24.

A second outlet 92 may be arranged at chemical compartment 26 for output of gas formed and/or unused from reactions occurring in chemical compartment 26. In some embodiments, carbon dioxide 82 generated from first chemical reaction 42 flow out of chemical compartment 26 through second outlet 92. In some embodiments a stream of substantially pure carbon dioxide gas is collected from chemical compartment 26.

A third outlet 94 may be arranged at cathode chamber 22 for output of gas formed and/or unused from reactions occurring in cathode chamber 22. In some embodiments, hydrogen gas 54 generated from second electrochemical reaction 36 flows out of cathode chamber 22 through third outlet 94. In some embodiments a stream of substantially pure hydrogen gas is collected from cathode chamber 22.

Oxygen gas 44, carbon dioxide 84 and/or hydrogen gas 54 are produced from separate chambers/compartment of cell 12. Each of the gaseous byproducts flow out from separate chambers/compartment of cell 12. This allows each of the gases to be stored and/or to participate in downstream processes directly without requiring pre-processing, such as by filtration or separation from impurities. The gaseous byproducts may be pure or substantially pure. In some example embodiments, one or more of the gaseous byproducts is greater than about 95% pure. In some embodiments, one or more of the gaseous byproducts is greater than about 99% pure.

One or more of anolyte pump 91, catholyte pump 93, first reactant pump 95, second reactant pump 97, and metal carbonate pump 99 may be connected to supply a flow of the respective feeds into cell 12.

In some embodiments, a recycle stream 98 fluidly connects cathode chamber 22 to anode chamber 24. Recycle stream 98 may be adapted to flow gas such as hydrogen gas generated from second electrochemical reaction 36 at cathode 18 out of cathode chamber 22 into anode chamber 24. Hydrogen gas generated from second electrochemical reaction 36 may be used in first electrochemical reaction 34 as first hydrogen-containing reactant 38.

In some embodiments, a processor 101 is arranged upstream of electrochemical cell 12. Processor 101 may for example be a grinder 101. In some embodiments, metal carbonate salt 56 is supplied to processor 101 for pretreatment. In some embodiments, metal carbonate salt 56 is pretreated by grinding or crushing into smaller particles. Processor 101 may comprise a filter 101. In some embodiments, a feed containing metal carbonate salt 56 is pretreated by selectively separating the metal carbonate salt 56 from other substances contained in the feed to remove impurities.

In some embodiments, an average diameter of the particles of metal carbonate salt 56 supplied to chemical compartment 26 is less than about 1 mm. In some embodiments, an average diameter of the particles of metal carbonate salt 56 supplied to chemical compartment 26 is in the range of from about 1 μm to about 300 μm.

Aspects of the invention relate to combining methods and apparatuses for converting metal carbonate salts to hydroxides with downstream methods and apparatuses for making useful products. FIG. 2 illustrates example apparatuses that may be arranged downstream of electrochemical cell 12 useful for processing one or more reaction products generated from electrochemical cell 12 to yield one or more additional useful products.

Metal hydroxides 88 produced from second chemical reaction 86 are removed from cathode chamber 22. In some embodiments, metal hydroxides 88 are removed by causing a flow of a mixture comprising catholyte 50 and metal hydroxides 88 out of cathode chamber 22. Metal hydroxides 88 may be separated from the flow by a suitable filtration process.

Metal hydroxides 88 may optionally be supplied to a processor 102. Processor 102 may be a separator adapted to remove undesired impurities such as any undesired byproducts of the reactions occurring in cathode chamber 22. Separator may implement any suitable separation methods and apparatuses may be used such as any physical separation methods (e.g., filtration) and/or chemical separation methods (e.g., extraction). In some embodiments, processor 102 comprises a dryer. Dryer may be adapted to dewater the metal hydroxides 88.

In some embodiments, metal hydroxides 88 are used in cement production. In some example embodiments, metal hydroxides 88 are calcium hydroxides. Calcium hydroxides may be used as a cement clinker precursor.

Metal hydroxides 88 are supplied to a reactor 104, for example a kiln 104. An admixture 106 may be added to reactor 104 to react with metal hydroxides 88 to yield cement clinker 108 under heat, for example at a temperature of about 1500° C.

In some embodiments, one or both oxygen gas 44 and hydrogen gas 54 is produced as gaseous byproducts from first electrochemical reaction 34 at anode 20 and second electrochemical reaction 36 at cathode 18 respectively. In some embodiments, one or both oxygen gas 44 and hydrogen gas 54 are used as reactants in a combustion reaction which produces heat. The produced heat may be used to heat reactor 104. The produced heat may be supplied to other downstream methods or apparatuses.

In some embodiments, admixture 106 comprises silicon dioxide (SiO₂) or silica. Silicon dioxide may react with calcium hydroxides in reactor 104 to form calcium silicates as cement clinker 108, in accordance with one or more of Equations 7-9.

3Ca(OH)₂₍ₛ₎+SiO₂₍ₛ₎→3CaO·SiO₂₍ₛ₎+3H₂O (Eq. 7)

2Ca(OH)₂₍ₛ₎+SiO₂₍ₛ₎→2CaO·SiO₂₍ₛ₎+3H₂O (Eq. 8)

1Ca(OH)₂₍ₛ₎+SiO₂₍ₛ₎→CaO·SiO₂₍ₛ₎+3H₂O (Eq. 9)

In some embodiments, carbon dioxide 82 generated from first chemical reaction 42 is removed from chemical compartment 26, for example, through outlet 92.

Carbon dioxide 82 may be directly supplied to one or more downstream apparatuses and/or methods. In some embodiments, the removed carbon dioxide does not participate in a carbon capture process prior to being supplied to the one or more downstream apparatuses and/or methods. In some embodiments, the removed carbon dioxide is not otherwise treated such as by separation or filtration before being supplied to the downstream apparatuses and/or methods.

In some embodiments, the removed carbon dioxide is supplied to a second electrochemical cell 110 to yield useful carbon-containing products. Second electrochemical cell 110 may be adapted to cause the reduction of carbon dioxide 82. In some example embodiments, second electrochemical cell 110 is a CO₂RR electrolyzer. In some embodiments, reaction products from the reduction of carbon dioxide 82 comprises useful carbon-containing products such as carbon monoxide, formate, formic acid, ethylene and propanol.

Other non-limiting applications for the removed carbon dioxide 82 include underground storage, mineralization, direct use in various industries such as in the food and beverage industry and thermochemical conversion into useful carbon-containing products.

### Example Reactor for Converting Metal Carbonates to Metal Hydroxides

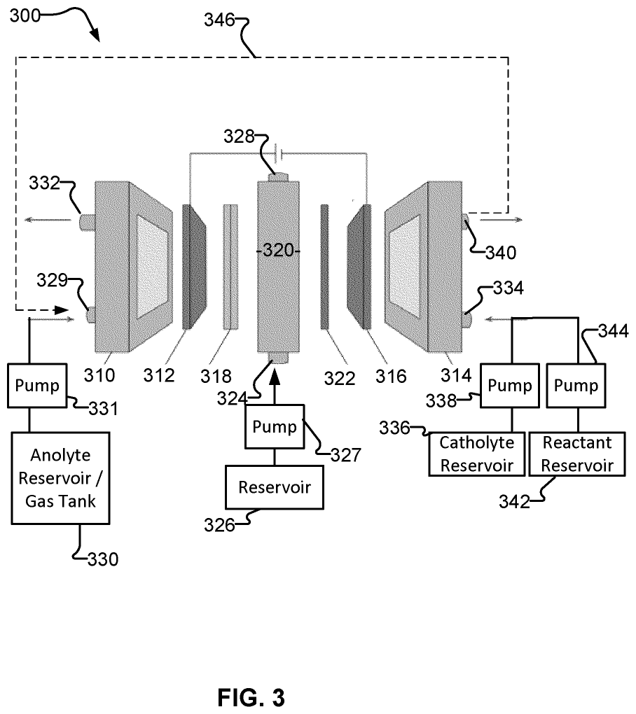

FIG. 3 is a schematic diagram showing an example reactor 300 which may be used to convert metal carbonates to metal hydroxides. In some embodiments, electrochemical cell 300 is a flow cell that comprises an anode housing 310 arranged to be pressed against an anode 312. A cathode housing 314 may be pressed against a cathode 316.

A first membrane 318 may be arranged to be pressed between anode 312 and a chemical compartment 320. In some embodiments, first membrane 318 is an ion exchange membrane adapted to allow passage of hydrogen ions. In some embodiments, first membrane 318 is a cation exchange membrane. In some embodiments, first membrane is a bipolar membrane.

A second membrane 322 may be arranged between cathode 316 and chemical compartment 320. In some embodiments, second membrane 322 is pressed against chemical compartment 320. In some embodiments, second membrane 322 is arranged to press against cathode 316. In other embodiments, a gap is arranged between cathode 316 and second membrane 322 such that second membrane 322 does not press against cathode 316.

In some embodiments, second membrane 322 is an ion exchange membrane adapted to selectively allow passage of positively charged ions and blocks passage of negatively charged ions. In some embodiments, second membrane 322 is adapted to allow passage of metal ions. In some embodiments, second membrane 322 is a cation exchange membrane.

An inlet 324 of chemical compartment 320 may be fluidly connected to a reservoir 326. Reservoir 326 contains metal carbonate salt. In some embodiments, reservoir 326 contains a mixture comprising metal carbonate salt and a suitable solvent. In some embodiments, a pump 327 is connected to supply the metal carbonate salt contained in reservoir 326 to chemical compartment 320 flowing through inlet 324 of chemical compartment 320.

An outlet 328 of chemical compartment 320 may be fluidly connected to a collector and/or a drain (not shown). Solvent exiting from chemical compartment 320 may be circulated back to reservoir 326.

In some embodiments, carbon dioxide gas flows out of chemical compartment 320 through outlet 328. In some embodiments the carbon dioxide gas is collected for supply to one or more downstream apparatuses for further processing. One of such downstream apparatuses include for example a second electrochemical cell.

Unreacted solvent, metal carbonate salt, and/or unwanted materials may flow out through outlet 328.

In some embodiments, anode housing 310 includes an inlet 329. In some embodiments, an anolyte reservoir 330 or a gas tank 330 is fluidly connected to inlet 329. Anolyte reservoir 330 may contain anolyte. Gas tank 330 may contain hydrogen gas. Anolyte or hydrogen gas may be delivered to anode 312 by flowing through inlet 329 of anode housing 310. A pump 331 may be connected to supply the anolyte or gas contained in reservoir or tank 330 to anode housing 310 though inlet 329. In other embodiments, anode housing 310 comprises an anode chamber which contains the anolyte.

Anode housing 310 may include one or more outlets 332. Outlets 332 may be fluidly connected to a collector and/or a drain. In some embodiments, oxygen gas is produced at anode 312. Oxygen gas may flow out of anode housing 310 through outlet 332. Anolyte, first hydrogen-containing reactant, and/or unwanted materials may flow out through outlet 332. The anolyte, if present is recirculated to anolyte reservoir 330 in some embodiments.

In some embodiments, cathode housing 314 includes an inlet 334. In some embodiments, a catholyte reservoir 336 is fluidly connected to inlet 334. Catholyte reservoir 336 may contain catholyte. A pump 338 may be connected to supply the catholyte from reservoir 336 to cathode housing 314 though inlet 334.

In some embodiments, a reservoir 342 containing a second hydrogen-containing reactant such as water is fluidly connected to inlet 334. A pump 344 may be connected to supply the reactant contained in reservoir 342 to cathode housing 314 though inlet 334.

Cathode housing 314 may include one or more outlets 340. Outlets 340 may be fluidly connected to a collector and/or a drain. In some embodiments, hydrogen gas is produced at cathode 316. Hydrogen gas may flow out of cathode housing 314 through outlet 340. Catholyte, second hydrogen-containing reactant, and/or unwanted materials may flow out through outlet 340. In some embodiments catholyte collected at outlet 340 is recirculated to catholyte reservoir 336.

In some embodiments, a recycle stream 346 connects outlet 340 of cathode housing 314 to inlet 329 of anode housing 310. Hydrogen gas flowing out of outlet 340 of cathode housing 314 may flow into anode housing 310 through inlet 329 to participate in electrochemical reactions occurring at anode 312.

### Example Methods for Converting Metal Carbonate Salts to Metal Hydroxides

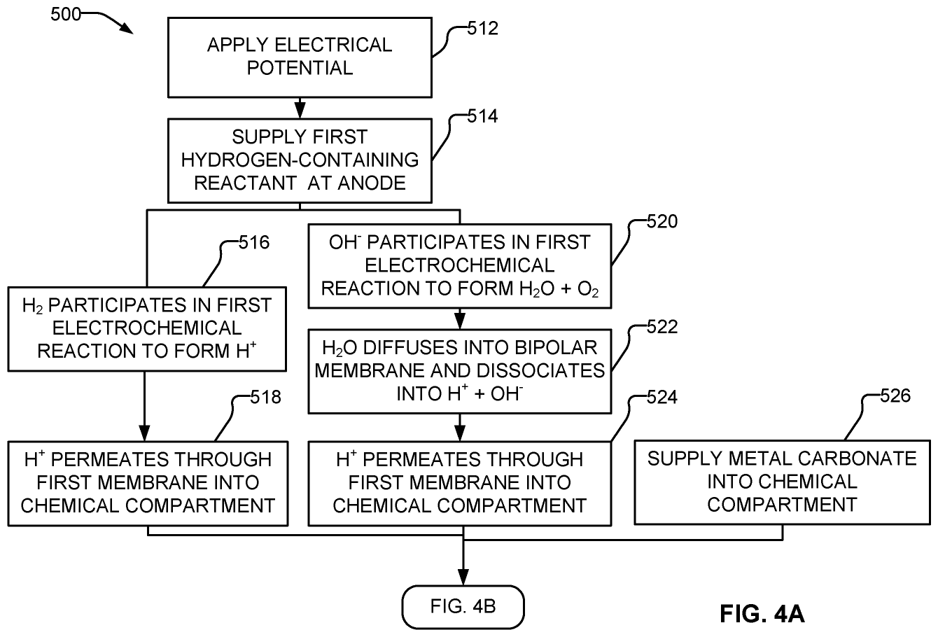

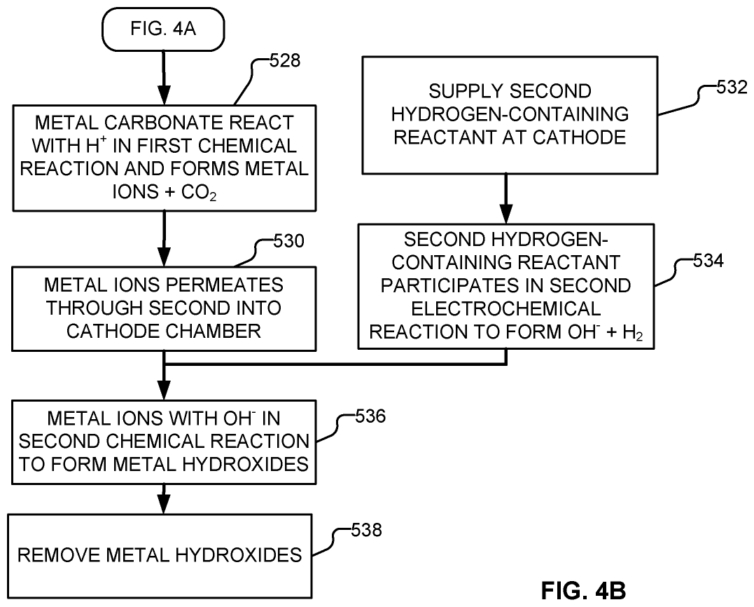

FIGS. 4A and 4B are flow charts illustrating the steps of an example method 500 of converting metal carbonate salts to metal hydroxides. Referring to FIG. 4A, in block 512, an electrical current and/or potential is applied between an anode and a cathode.

In block 514, a first hydrogen-containing reactant is supplied at the anode.

In some embodiments, the first hydrogen-containing reactant such as hydrogen gas (H₂) undergoes a first electrochemical reaction to produce hydrogen ions (H⁺) (block 516). The hydrogen ions permeate through a first membrane such as an ion exchange membrane to enter a chemical compartment (block 518).

In some embodiments, the first hydrogen-containing reactant such as a base undergoes a first electrochemical reaction to produce an intermediate molecule such as a water molecule (block 520). In block 522, the water molecule pass through a first membrane such as a bipolar membrane within which the water molecule participates in a further electrochemical reaction to be electrochemically dissociated into hydrogen ions and hydroxide ions (OH⁻). The hydrogen ions permeate through the first membrane to enter a chemical compartment (block 524).

In block 526, a feed of metal carbonate salt may be supplied to the chemical compartment. Referring to FIG. 4B, carbonate ions from the metal carbonate salt may participate in a first chemical reaction by reacting with hydrogen ions. Metal carbonate salt decomposes into metal ions and carbon dioxide (block 528). In block 530, the metal ions permeate through a second membrane such as an ion exchange membrane to enter a cathode chamber.

In block 532, a second hydrogen-containing reactant is supplied at the cathode chamber. The second hydrogen-containing reactant such as water undergoes a second electrochemical half reaction at the cathode to produce hydroxide ions and hydrogen gas (block 534).

In block 536, the metal ions participate in a second chemical reaction by reacting with hydroxide ions to produce metal hydroxides. In block 538, metal hydroxides are removed from the cathode chamber.

The first electrochemical reaction at block 516 or the first electrochemical reaction at block 520 and the further electrochemical reaction 522 may be performed in tandem with the second electrochemical reaction at block 534 and the first and second chemical reactions at blocks 528, 536.

In some embodiments, hydrogen gas generated from the second electrochemical reaction in the cathode chamber at block 534 is recycled to the anode chamber for re-use in subsequent first electrochemical reactions (such as at block 516 in which hydrogen gas is the first hydrogen-containing reactant).

In some embodiments, produced metal hydroxides are supplied to a reactor, such as a kiln for reacting with an admixture such as silicon dioxide (SiO₂) to yield cement clinkers.

In some embodiments, carbon dioxide generated from the first chemical reaction in block 528 is removed from the cell. The carbon dioxide may be directly supplied to one or more downstream apparatuses and/or methods. In some embodiments, the removed carbon dioxide does not participate in a carbon capture process prior to being supplied to the one or more downstream apparatuses and/or methods. In some embodiments, the removed carbon dioxide is supplied to a second electrochemical cell to participate in a CO₂RR to yield carbon-containing compounds.

Method 500 may be tuned to optimize one or more of current efficiency, applied electrical potential to achieve a desired current efficiency, product selectivity, efficiency and reaction rate of each of the electrochemical reactions and chemical reactions by adjusting one or more of:
characteristics of the ion exchange membrane such as the thickness, porosity, etc.; and/or.
characteristics of the anode and/or cathode electrodes such as the material and method of fabrication; and/or.
nature of the cathode and/or anode catalyst;
additional catalysts present; and/or.
conditions of the flow cell such as temperature, pH, pressure, etc.; and/or.
the type of solvent and electrolyte in the area where each reaction takes place; and/or
flow rate of the metal carbonate salt and/or solvent; and/or
flow rate and/or composition of the first and second hydrogen-containing reactants and/or solvent and/or catholyte and/or anolyte; and/or.
rate at which metal hydroxide is removed from the cathode chamber; and/or size of the metal carbonate salt supplied to the chemical compartment;
distance across the chemical compartment between first and second membranes; etc.

At least some of these factors may be separately optimized for each of the electrochemical and chemical reactions to achieve:
low applied electrical potentials at desired current efficiencies and/or
high current efficiencies;
high rates of formation of the products; and/or.
high selectivity of the desired products at each of the anode and cathode chambers and the chemical reaction compartment; and/or.
low amounts of solid precipitation and/or accumulation on any of the electrodes; and/or
high purity of the reaction products and/or gaseous byproducts, etc.

In some embodiments, an electrical potential difference applied between cathode 18 and anode 20 introduces a current density of at least about 100 mA cm⁻². For example, in some embodiments the current density within cell 12 is maintained in the range of about 90 mA/cm⁻² to about 500 mA cm⁻². In some embodiments, the current density is maintained at a level of at least 100 mA cm⁻².

In some embodiments, the electrical potential difference applied between cathode 18 and anode 20 to maintain the current density at a level of at least 100 mA cm⁻² is less than about 5 V. In some embodiments, the electrical potential difference applied between cathode 18 and anode 20 to maintain the current density at a level of at least 100 mA cm⁻² is in the range of from about 1.5 to about 5 V.

In some embodiments, a distance across chemical compartment 26 is less than a distance across anode chamber 24 and/or a distance across cathode chamber 22. In some example embodiments, a distance across chemical compartment 26 is about 10 times smaller than a distance across anode chamber 24 and/or cathode chamber 22.

In some embodiments, the thickness of first and/or second membranes 28, 30 is in the range of from about 10 μm to about 250 μm. In some embodiments, the thickness of first membrane 28 is greater than the thickness of second membrane 30.

In some example embodiments in which cathode chamber 22, anode chamber 24, and chemical compartment 26 are separated by first and second ion exchange membranes 60, 84, the thickness of first ion exchange membrane 60 is in the range of from about 10 to about 100 μm. The thickness of second ion exchange membrane 84 may be in the range of from about 100 to about 250 μm. In some embodiments, the thickness of first ion exchange membrane 60 is in the range of from about 10 to about 50 μm. The thickness of second ion exchange membrane 84 may be in the range of from about 150 to about 200 μm. In some embodiments, first ion exchange membrane 60 is a Nafion™ 211 membrane. In some embodiments, second ion exchange membrane 84 is a Nafion™ 117 membrane.

In some example embodiments in which bipolar membrane 66 separates anode chamber 24 and chemical compartment 26, and second ion exchange membrane 84 separates chemical compartment 26 and cathode chamber 22, the thickness of bipolar membrane 66 is in the range of from about 25 to about 250 μm. The thickness of second ion exchange membrane 84 may be in the range of from about 100 to about 200 μm. In some embodiments, bipolar membrane 66 is a product commercially available under the product name Fumasep™ FBM. In some embodiments, biopolar membrane 66 is fabricated by combining a cation exchange layer (such as a Nafion™ 211 membrane) and an anion exchange layer (such as a Aemion™ CNN-8-25X membrane). In some embodiments, second ion exchange membrane 84 is a Nafion™ 117 membrane.

In embodiments in which first hydrogen-containing reactant 38 comprises an anolyte, a flow rate at which the anolyte is delivered to anode 20 may, for example, be in the range of from about 100 to 800 mL min⁻¹ for an electrode having a geometric surface area of 2.6 cm². The flow rate may be scaled according to the area of the electrode. In some embodiments, a flow rate at which the anolyte is delivered to anode 20 is in the range of from about 300 to 500 mL min⁻¹ for an electrode having a geometric surface area of 2.6 cm².

In some embodiments, a flow rate at which second hydrogen-containing reactant 52 is delivered to cathode 18 is in the range of from about 100 to 800 mL min⁻¹ for an electrode having a geometric surface area of 2.6 cm². In some embodiments, a flow rate at which second hydrogen-containing reactant 52 is delivered to cathode 18 is in the range of from about 300 to 500 mL min⁻¹ for an electrode having a geometric surface area of 2.6 cm². In some embodiments, the flow rate at which second hydrogen-containing reactant 52 is delivered to cathode 18 is in the range of from 100 to 200 mL min⁻¹ per cm² of an electrode. The flow rate may be scaled according to the area of the electrode.

In some embodiments, the concentration of metal carbonate salt 56 in solvent 59 supplied to chemical compartment 26 is in the range of from about 5 g/L to about 50 g/L per cm² of an electrode. The concentration may be scaled according to the area of the electrode.

In some embodiments, the concentration of anolyte supplied to anode 24 is in the range of from about 0.1 to about 5 M. In some embodiments, the concentration of anolyte supplied to anode 24 is less than about 5 M.

In some embodiments, anode chamber 24 is maintained at a pH of greater than about 11. In some embodiments, the pH of anode chamber 24 is maintained in the range of from about 12 to 14.

In some embodiments, the pH of chemical compartment 26 is maintained in the range of from about 2 to about 7 during electrolysis. In some embodiments, the pH of chemical compartment 26 is maintained in the range of from about 4 to about 6.5 during electrolysis.

In some embodiments, cathode chamber 22 is maintained at a pH of greater than about 10 during electrolysis. In some embodiments, the pH of cathode chamber 22 is maintained in the range of from about 10 to about 13 during electrolysis.

In some embodiments, the electrolysis is operated at a temperature in the range of from 25° C. to about 60° C. In some embodiments, the electrolysis is operated at a temperature less than about 60° C.

In some embodiments, one or more of first hydrogen-containing reactant 38, catholyte 50, second hydrogen-containing reactant 52, and metal carbonate salt 56 are heated to a selected temperature before participating in their respective electrochemical and chemical reactions 34, 36, 42, 86. In some embodiments, one or more first hydrogen-containing reactant 38, catholyte 50, second hydrogen-containing reactant 52, and metal carbonate salt 56 are heated to a temperature in the range of from about 40° C. to about 60° C.

In summary, one example aspect of the invention provides an electrochemical apparatus and methods to convert metal carbonate salts to metal hydroxides. This conversion may involve the conversion of calcium carbonate to calcium hydroxide for use in cement clinker, or lanthanum carbonate to lanthanum hydroxide for use in optic and ceramic applications.

One aspect of the invention provides a three-compartment “cement electrolyzer” that is operable to produce Ca(OH)₂₍ₛ₎ at high rates while generating a pure CO_{2(g)} gas stream that can optionally be subsequently converted in a CO₂RR electrolyzer. This system, which converts limestone into cement clinker precursor Ca(OH)₂₍ₛ₎ at current densities >100 mA cm⁻² may comprise an anode, chemical, and cathode compartments. A bipolar membrane (BPM) may separate the anode compartment from the chemical compartment, and a cation exchange membrane may separate the chemical compartment from the cathode compartment. A CaCO₃₍ₛ₎ feedstock may be provided to the chemical compartment as an aqueous slurry. In some embodiments, under a reverse bias, the BPM dissociates water and supplies H⁺ to the chemical compartment to convert CaCO₃₍ₛ₎ into Ca²⁺ and CO_{2(g)}. The CO_{2(g)} may exit the chemical compartment as a pure gas stream, while Ca²⁺ is transported across the CEM to the cathode compartment. In the cathode compartment, the Ca²⁺ may react with OH-generated at the cathode to form Ca(OH)₂₍ₛ₎.

In some embodiments, the electrolyzer forms Ca(OH)₂₍ₛ₎ at a rate of 78.4 mg h⁻¹ (at 45 mA cm⁻²) for an anode and cathode having an geometric surface area of 2.6 cm⁻² while generating pure O_{2(g)}, CO_{2(g)}, and H_{2(g)} streams at the anode, chemical, and cathode compartments, respectively.

In some embodiments, supplying the CO_{2(g)} stream to a CO₂RR electrolyzer results in about >60% of the CO_{2(g)} produced from CaCO₃₍ₛ₎ decomposition being converted into CO_{(g)} in a downstream CO₂RR electrolyzer without further separation or purification.

An aspect of the invention provides a flow electrolyzer that mediates the conversion of CaCO₃₍ₛ₎ into high purity Ca(OH)₂₍ₛ₎ at >100 mA cm⁻² with 57% current efficiency. The energy needed to electrochemically produce Ca(OH)₂₍ₛ₎ is 324 KJ mol⁻¹, which is ˜10% higher than the energy required to thermally produce CaO(s) (293 kJ mol⁻¹). However, the electrochemical pathway allows for the use of clean electricity in place of heat derived from the combustion of fossil fuels. The disclosed electrochemical process can yield a CO_{2(g)} byproduct that is relatively pure and may be fed directly to a CO₂RR electrolyzer without purification. This CO₂RR electrolyzer can eliminate >30% of the CO_{2(g)} emitted or released from the flow electrolyzer in the conversion of CaCO₃₍ₛ₎ to Ca(OH)₂. This reduction in CO_{2(g)} emissions would be >50% reduction in CO_{2(g)} emissions required to make cement clinkers if all the CO_{2(g)} from CaCO₃₍ₛ₎ decomposition is converted into CO_{(g)}.

The invention is further described with reference to the following specific examples, which are not meant to limit the invention, but rather to further illustrate it.

### EXAMPLES

### Example 1—Comparison of HOR and OER Electrolyzers

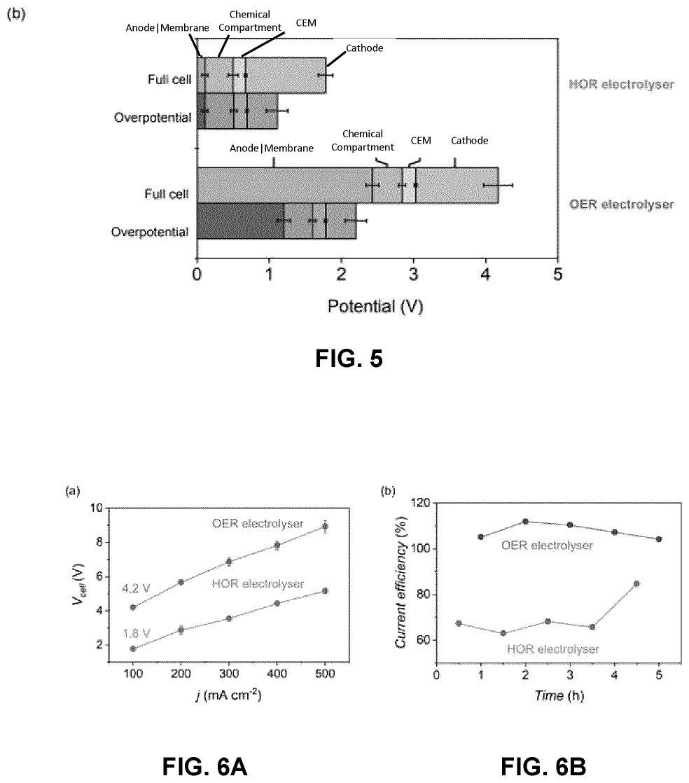

An electrochemical cell of the type illustrated in FIG. 1A and the method of performing electrolysis illustrated in FIGS. 5A and 4B were used to convert calcium carbonate to calcium hydroxide. In the example embodiment, anode 24 comprises platinum on carbon (Pt/C furnished carbon paper). Cathode 22 comprises a free-standing nickel foam. First membrane 28 is an ion exchange membrane commercially available under the product name Nafion™ 211. First membrane 28 has a thickness of 25 μm. Second membrane 30 is an ion exchange membrane commercially available under the product name Nafion™ 117. Second membrane 30 has a thickness of 175 μm. The first hydrogen-containing reactant used in this example embodiment is humidified H₂ gas. The second hydrogen-containing reactant is water. The catholyte used is 1.0 M KCl. The CaCO₃ is supplied as an aqueous slurry. 20 g/L of CaCO₃ is suspended in 1.0M CaCl₂) solution. The flow rates at which each of CaCO₃ and catholyte is supplied to the cell is 300 mL/min. This system is also referred to herein as the “HOR electrolyzer”.

An electrochemical cell of the type illustrated in FIG. 1B and the method of performing electrolysis illustrated in FIGS. 5A and 4B were also used to convert calcium carbonate to calcium hydroxide. In the example embodiment, anode 24 and cathode 22 each comprises a free-standing nickel foam. First membrane 28 is bipolar membrane commercially available under the product name Fumasep FBM. First membrane 28 has a thickness of 195 μm. Second membrane 30 is an ion exchange membrane commercially available under the product name Nafion™ 117. Second membrane 30 has a thickness of 175 μm. The first hydrogen-containing reactant used in this example embodiment is 1.0 KOH. The second hydrogen-containing reactant is water. The catholyte used is 1.0 M KCl. The CaCO₃ is supplied as an aqueous slurry. 20 g/L of CaCO₃ is suspended in 1.0M CaCl₂) solution. The flow rates at which each of CaCO₃, anolyte and catholyte is supplied to the cell is 300 mL/min. This system is also referred to herein as the “OER electrolyzer”.

### Example 1.1—Voltage Drop Measurements

The voltage drop across each component for both the HOR electrolyzer and the OER electrolyzer configurations during the production of Ca(OH)₂ are compared as shown in FIG. 5. The voltage across the anode and adjacent membrane are displayed as a single component (denoted as “Anode|Membrane”) to compare the voltage associated with proton generation. FIG. 5 shows that the HOR electrolyzer is a more thermodynamically favourable means of sourcing protons compared to the OER electrolyzer, and exhibits lower overpotentials on the membrane and anode. A full cell voltage (V_{cell}) of 1.77 V at 100 mA cm⁻² was achieved with the HOR electrolyzer. The HOR electrolyzer exhibited a combined membrane and anode overpotential of 0.11 V at 100 mA cm⁻². A full cell voltage (V_{cell}) of 4.20 V at 100 mA cm⁻² was achieved with the OER electrolyzer. The OER electrolyzer exhibited a combined membrane and anode overpotential of 1.14 V at 100 mA cm⁻².

### Example 1.2—Cell Voltage and Current Efficiency

FIG. 6A is a plot of the cell voltage (V_{cell}) as a function of current density j (mA cm⁻²) comparing the cell voltages required to convert calcium carbonate to calcium hydroxide using the HOR electrolyzer and the OER electrolyzer. Electrolysis experiments at current densities between 100 and 500 mA cm⁻² were conducted using each of the HOR and OER electrolyzers. The HOR electrolyzer required voltages as low as 1.77 V at 100 mA cm⁻². The OER electrolyzer required 4.2 V to operate at 100 mA cm⁻².

FIG. 6B is a plot of the current efficiency (%) as a function of time (h) comparing the current efficiencies of the OER and HOR electrolyzers over five hours of electrolysis. The current efficiency of the OER and HOR electrolyzers were both stable over five hours of electrolysis. The OER electrolyser achieved consistently higher current efficiencies (˜100%) relative to the HOR electrolyser (70-90%) at 100 mA cm⁻². The inventors believe that this difference may be due to non-ideal proton transport across CEMs in contrast to BPMs which exhibit nominal ion crossover. The proportion of current carried by protons is referred to as the proton transference number. For BPMs, proton transference numbers are typically close to 1.1 Conversely, Nafion™ membranes can transport other cations (e.g., K+) and also permit the transport of co-ions (e.g., Cl⁻, OH⁻), which would both decrease the proton transference number and the rate of i-CO₂ formation (i.e., current efficiency).

### Calculation of Current Efficiency

Protons delivered to the chemical compartment are sourced either from water dissociation in a bipolar membrane (BPM) or by the hydrogen oxidation reaction (HOR) at the anode. These protons can react either with CaCO₃ in the chemical compartment (Eq. S1) or be transported across the cation-exchange membrane (CEM) and react with OH-generated in the cathode compartment. The current efficiency is defined as the percentage of protons generated by the BPM that react with CaCO₃ to form Ca²⁺ and CO₂ (Eq. S2).

CaCO₃₍ₛ₎+2H⁺_{(aq)} [symbol] Ca²⁺_{(aq)}+CO_{2(g)}+H₂O Eq. S1

$$Current efficiency = \frac{Protons reacted with {CaCO}_{{3}_{s}}}{Total protons generated by BPM or HOR} \times 100 \% \qquad Eq . S2$$

The inventors determined the current efficiency of each cement electrolyser by measuring the flow rate (Fᵥ) and concentration of the CO_{2(g)} stream generated as a byproduct of CaCO₃ decomposition (Eq. S3). The current efficiency is calculated according to Eq. S3:

$$Current efficiency = ( {F}_{m} χ ) / ( I / nF ) \qquad Eq . S3$$

Where Fₘ is the molar flow rate of gaseous species released from the chemical compartment of the cement electrolyser, x is the mole fraction of CO₂ in this gaseous stream, I is the total current that passes through the electrode, n is the charge transfer number (n=2 in this case), and F is Faraday's constant (F=96,485 C/mol). The molar flow rate is derived from the volumetric flow rate Fᵥ by the relation Fₘ=pFᵥ/RT, where p is the atmospheric pressure in Pa, R is the ideal gas constant (8.314 J/mol K), and T is the temperature in degrees Kelvin.

### Example 1.3—FTIR Characterization of Ca(OH)₂

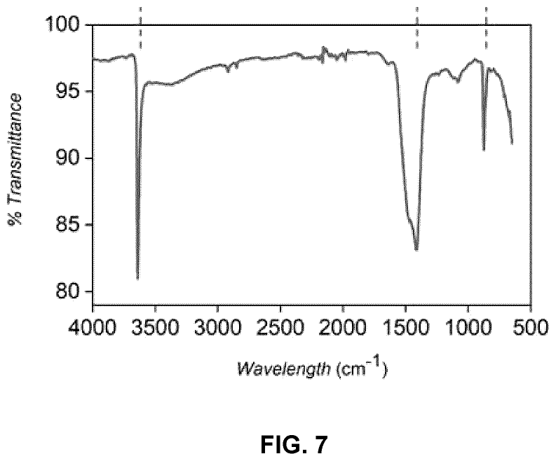

FIG. 7 is a Fourier-transform infrared spectroscopy (FTIR) graph of the solid reaction product Ca(OH)₂ generated in the cathode compartment after an electrolysis experiment. The reaction product was manually collected and dried for characterization by FTIR. Dashed lines correspond to characteristic peaks of Ca(OH)₂₍ₛ₎ at 3647, 1428 and 876 cm⁻¹.

### Example 1.4—Voltage Drop Measurements

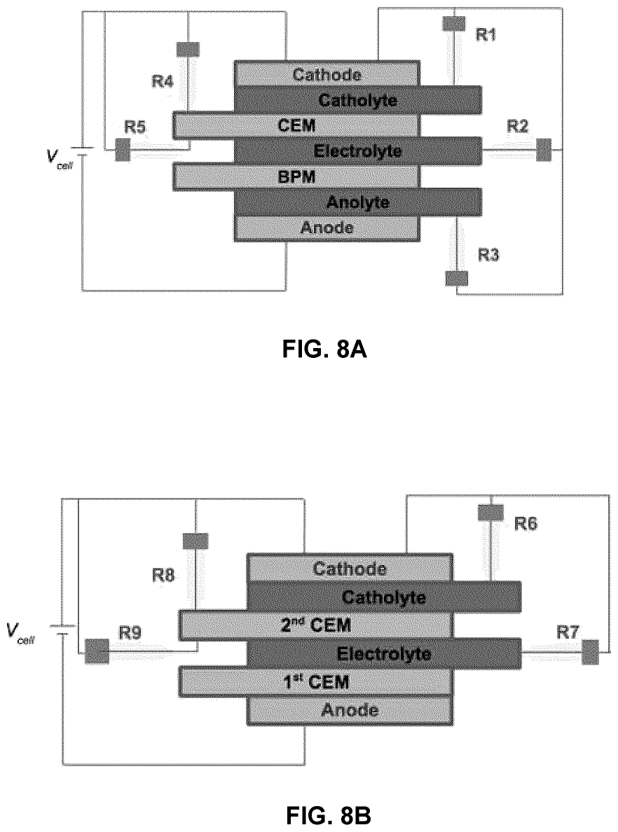

FIGS. 8A and 8B are schematic diagrams of a pair of diagnostic cement electrolyzers, OER electrolyzer and HOR electrolyzer respectively, showing the reference electrode placement for three-electrode voltage measurement.

Referring to FIG. 8A, the R1, R2, R3, R4 and R5 labels indicate the position of the reference electrode when measuring the voltage drops V1, V2, V3, V4 and V5, respectively at 100 mA cm⁻². The working electrode corresponds to the cathode, while the counter electrode corresponds to the anode.

Referring to FIG. 8B, R6, R7, R8 and R9 labels indicate the position of the reference electrode when measuring the voltage drops V6, V7, V8 and V9, respectively at 100 mA cm⁻². The working electrode corresponds to the cathode, while the counter electrode corresponds to the anode.

Voltage loss across each component in both electrolyzer configurations was measured.

### OER Electrolyzer Voltage Measurements

The voltage drop across each electrolyser component at 100 mA cm⁻² was measured using a reference electrode immersed in electrolytes supplied to the anode, chemical, and cathode compartments. These measurements were enabled by the use of T-tubes in the electrolyte tubing used to insert Ag/AgCl (aq, saturated KCl) reference electrodes at any desired location. This mode of insertion places the reference electrodes in direct contact with the electrolyte and ionically connects the reference to the cathode, anode, and membranes. The inventors used a two-electrode configuration to measure the ohmic voltage drop between the Ag/AgCl reference inserted in the T-tube and the cathode or anode (V_{tube}, ˜0.1 V). Voltages were measured against the Ag/AgCl reference electrode and converted to the standard hydrogen electrode (SHE) according to Eq. S4. All reported voltages in this study were measured at 100 mA cm⁻² and are reported against VSHE unless otherwise stated.

$${V}_{SHE} = {V}_{Ag / AgCl} + 0.197 V \qquad Eq . S4$$

The voltage drop across each component of both electrolyser configurations was calculated by performing a series of measurements where the Ag/AgCl reference electrode was inserted at various locations (FIGS. 8A, 8B). The inventors measured the voltage drop across the cation-exchange membrane (CEM) adjacent to the cathode compartment by using a larger CEM that extends outside the electrolyser in order to connect a reference electrode to both sides of the membrane (FIG. 8A, R4 and R5). The voltage drop across the CEM is calculated according to Eq. S5. The voltage drops on the anode and cathode were calculated according to Eq. S6 and Eq. S7. The voltage drop between the T-tubes and electrode is accounted for by V_{tube} in V_{anode} and V_{cathode} calculations. The voltage drop through the anolyte (1 M KOH) and catholyte (1 M KCl) were assumed to be negligible due to the high conductivity of the electrolytes and because the Ni foam cathode and anode were pressed directly against the adjacent membranes (i.e., a zero-gap configuration).

$${V}_{CEM} = {V}_{5} - {V}_{4} \qquad Eq . S5$$

$${V}_{anode} = {V}_{cell} - {V}_{3} - {V}_{tube} \qquad Eq . S6$$

$${V}_{cathode} = {V}_{1} - {V}_{tube} \qquad Eq . S7$$

The voltage drop across the chemical compartment was measured indirectly because a reference electrode placed at the R2 position (FIG. 8A) is situated in the middle of the chemical compartment and measures only half of the ohmic drop across this compartment. The inventors therefore calculated the voltage drop across the chemical compartment by Eq. S8-10. The voltage drop between V2 and V1 is assumed to consist of two components: i) the voltage drop across the cathode CEM (V_{CEM}) and ii) half of the ohmic overpotential of the chemical compartment (V_{1/2 chemical compartment}).

$${V}_{CEM} + {V}_{1 / 2 chemical compartment} = {V}_{2} - {V}_{1} \qquad Eq . S8$$

The inventors rearranged this expression and used the measured value of V_{CEM} to determine V_{1/2 chemical compartment}.

$${V}_{1 / 2 chemical compartment} = {V}_{2} - {V}_{1} - {V}_{CEM} \qquad Eq . S9$$

Therefore, V_{chemical compartment} can be calculated according to the following expression:

$${V}_{chemical compartment} = 2 \times ( {V}_{2} - {V}_{1} - {V}_{CEM} ) \qquad Eq . S10$$

### HOR Electrolyser Voltage Measurements

Voltage measurements for the HOR electrolyser were conducted using the same methodology as for the OER electrolyser. External reference electrodes were inserted into T-tubes located at the inlet of the chemical and cathode compartments. However, while a liquid anolyte (1 M KOH) was supplied to the OER electrolyser, gaseous H₂ was fed to the anode of the HOR electrolyser which precludes measuring the anode voltage through a T-tube in the electrolyte supply. The inventors therefore present the voltage drop across the Pt/C anode and adjacent “anode CEM” as a single component (V_{anode|CEM}). The inventors refer to the CEM that separates the chemical and cathode compartments as “cathode CEM” to distinguish between the two CEMs in the HOR electrolyser. Values for V_{anode|CEM} and V_{cathode} were calculated according to Eq. S11 and Eq. S12.

$${V}_{anode \vert CEM} = {V}_{cell} - {V}_{7} - {V}_{tube} \qquad Eq . S11$$

$${V}_{cathode} = {V}_{6} - {V}_{tube} \qquad Eq . S12$$

The voltage drop on the cathode CEM was calculated using Eq. S13.

$${V}_{cathode \vert CEM} = {V}_{9} - {V}_{8} \qquad Eq . S13$$

The voltage drop on the chemical compartment was calculated using Eq. S14.

$${V}_{chemical compartment} = 2 \times ( {V}_{7} - {V}_{6} - {V}_{Cathode CEM} ) \qquad Eq . S14$$

The results show that the OER and BPM constitute 56% (2.37 V) of the V_{cell} for the OER electrolyser with a combined overpotential of 1.14 V. Conversely, the voltage for the HOR and CEM in the HOR electrolyser comprise only 6% of the V_{cell} with 0.11 V of overpotential. The voltage drops across the chemical compartment, the CEM separating chemical and cathode compartments, and cathode were measured to be 0.39, 0.18, and 1.12 V respectively. The Ni foam cathode exhibited a relatively high overpotential of 0.53 V which indicates additional room for improvement with a more HER-active cathode or improved precipitate management.

### Example 1.5—Techno-Economic Model

### Analysis Scope

The inventors developed a techno-economic model that considers the integration of HOR and OER electrolysers within the cement manufacturing process to forecast the potential impact of OER and HOR electrolysers.

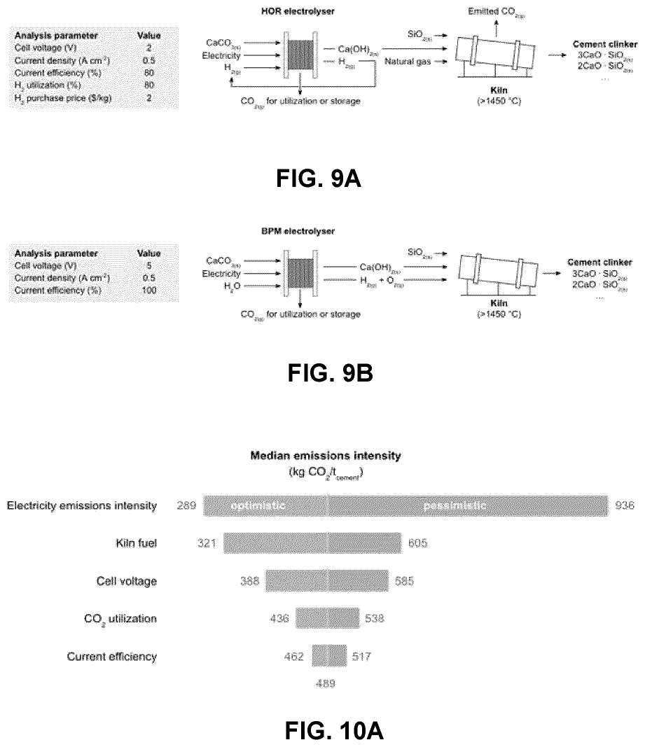

FIG. 9A is a schematic diagram illustrating the pathway for electrochemical cement production using a HOR electrolyzer to generate clinker precursors. As shown in FIG. 9A, with the HOR electrolyzer, the H_{2(g)} stream generated at the cathode is recycled to the anode where hydrogen oxidation occurs and the Ca(OH)₂₍ₛ₎-fed kiln is heated with natural gas.

FIG. 9B is a schematic diagram illustrating the pathway for electrochemical cement production using an OER electrolyzer to generate clinker precursors. As shown in FIG. 9B, with the OER electrolyzer, the H_{2(g)} stream generated at the cathode is combusted with the O_{2(g)} stream generated at the anode as the primary source of thermal energy for heating the Ca(OH)₂₍ₛ₎-fed kiln.

In both the FIGS. 9A and 9B pathways, the pure CO₂ (g) stream generated by decomposition of the CaCO₃₍ₛ₎ feedstock is assumed to be completely utilized or captured.

The techno-economic model analysis calculates the energy, CO_{2(g)} emissions, and cost to make 1 metric tonne of Portland cement (t_{cement}=95% clinker, 5% CaSO₄) by electrochemically generating Ca(OH)₂₍ₛ₎ and converting it into clinker through a thermal step in a high-temperature kiln. The energy demand for each pathway was calculated based on the operating voltage of OER and HOR electrolysers, the thermal energy requirements of the Ca(OH)₂₍ₛ₎-fed kiln, and electricity demand of auxiliary equipment. The CO_{2(g)} emissions intensity for each pathway encompasses both Scope 1 emissions from on-site fuel use and Scope 2 emissions from off-site electricity generation. The inventors assume that all CO_{2(g)} released from CaCO₃ decomposition is captured or utilized. The production cost for each pathway corresponds to the breakeven selling price for a cement plant with a 3000 t_{cement} per day capacity containing either a OER or HOR electrolyser unit in place of a precalciner. The analysis framework and assumptions are described in detail in the Supporting Information and key economic assumptions are summarized in Table 1 (financial values are in USD 2020). This analysis informs on whether the H_{2(g)} byproduct generated at the cathode of cement electrolysers would be better utilized as a reactant for the HOR in the HOR configuration, or as a fuel to heat the high-temperature kiln with the OER configuration.

TABLE 1
Economic assumptions used in cost analysis

| Plant specifications | Value | | Source |
|---|---|---|---|
| Production scale (t_{cement}/year) | 3000 | | |
| Capacity factor (%) | 90 | | Assumption |
| Project life (years) | 30 | | Assumption |
| Construction time (years) | 3 | | Assumption |
| Discount rate (%) | 8 | | |
| Direct capital cost (CAPEX_{ref}) of | 223 | | |
| reference cement plant ($M USD) | | | |
| Precalciner cost (% of CAPEX_{ref}) | 11 | | |
| Contingency, indirect and | 40 | | |
| ownership cost (% of CAPEXₜₒₜₐₗ) | | | |
| Electricity demand for auxiliary | 157 | | |
| equipment (kWh/t_{cement}) | | | |
| Electrolyser unit | HOR | OER | Source |
| Electrolyser cost | 20 | 16 | |
| (CAPEX_{electrolyser}, $M USD) | | | |
| CO₂ compression unit cost | 9.2 | 9.2 | |
| (CPU, $M USD) | | | |
| Balance of plant ($M USD) | 10.9 | 9.7 | Calculated |
| Total capital cost (CAPEXₜₒₜₐₗ) | 335 | 326 | Calculated |

| Fixed operating costs (OPEX_{fixed}) | Value | Source |
|---|---|---|
| Raw meal cost ($USD/tonne) | 4.49 | |
| CaCO₃ content in raw meal (%) | 80 | |
| Unit water cost ($CAD/m³) | 2.25 | British |
| | | Columbia,* |
| Monthly water cost ($CAD/month) | 580 | British |
| | | Columbia* |
| Insurance and tax (% of CAPEXₜₒₜₐₗ) | 2 | |
| Annual maintenance (% of CAPEXₜₒₜₐₗ) | 3 | |
| Operating personnel (number of persons) | 100 | |
| Average personnel salary ($USD/year) | 60,000 | |
| Maintenance labor (% of annual | 40 | |
| maintenance cost) | | |
| Administrative and support labor | 30 | |
| (% of total labor cost) | | |

*provided by the Government of British Columbia, Canada (Water Licenses & Approvals, https://www2.gov.bc.ca/gov/content/environment/air-land-water/water/water-licensing-rights/water-licences-approvals/water-application-fees-rental-rates, Accessed Dec. 12, 2022)

### Calculation of Energy Consumption

The energy demand for each electrochemical cement production pathway was calculated based on the voltage and current efficiency of HOR and BPM cement electrolysers, the thermal energy demand of the Ca(OH)Ca(OH)₂-fed kiln, and electricity demand of auxiliary equipment (157 kWh/t_{cement}) including a CO₂ compression unit. The cell voltages, current efficiencies, and associated metrics used in the analysis are summarized in FIGS. 9A and 9B. These metrics were chosen based on experimental data from this study and the current-voltage characteristics of analogous electrochemical devices. The energy demand of the Ca(OH)₂₍ₛ₎-fed kiln was calculated by adjusting the thermal energy demand of a modern CaCO₃₍ₛ₎-fed kiln (3.0 GJ/t_{cement}) for the difference in free energy between the decomposition of Ca(OH)₂₍ₛ₎ and CaCO₃₍ₛ₎ into CaO (and H₂O or CO₂). The calculated energy demand of the Ca(OH)₂₍ₛ₎-fed kiln (2.96 GJ/t_{cement}) therefore represents the sum of the minimum thermodynamic energy required to decompose Ca(OH)₂ into CaO and H₂O (139 KJ/mol CaO at 900 K), and the additional energy to convert CaO and SiO₂ into clinker [45% of the energy consumption of a CaCO₃₍ₛ₎-fed kiln]. In the OER pathway, the inventors assume that 2.52 GJ/t_{cement} of thermal energy can be sourced from the combustion of H_{2(g)}/O_{2(g)} streams released from the cement electrolyser with 80% thermal efficiency. The inventors assume that the remaining 0.44 GJₜₕₑᵣₘₐₗ is sourced from the combustion of natural gas (NG). For the HOR pathway, the inventors assume that the Ca(OH)_{2(g)}-fed kiln is heated solely using NG while the H_{2(g)} is recirculated to the anode. The reference case assumes that a CaCO₃-fed kiln with a thermal energy demand of 3.3 GJ/t_{cement} is heated using hard coal.

### Calculation of Emissions Intensity

The CO₂ emissions intensity (i.e., carbon intensity) of each electrochemical cement production pathway was calculated based on the carbon intensity of electricity generation and fuels used to heat the Ca(OH)₂-fed kiln (Table 2). The inventors assume 100% utilization of the pure CO₂ (g) stream released from the chemical compartment of OER and HOR electrolysers (i.e., no process emissions). Electricity generation in the current scenario was assumed to be sourced from a relatively low-carbon grid with an emissions intensity similar to the national average in Canada (0.150 kg CO₂/kWh). In the optimistic scenario we use an emissions intensity factor representative of modern solar installations (0.04 kg CO₂/kWh). Emissions from the combustion of fossil fuels to heat the Ca(OH)₂-kiln were calculated using widely reported emissions factors for commonly used kiln fuels (Table 2).

TABLE 2
Kiln fuel specifications

| | Cost | Net | Emissions |
|---|---|---|---|
| | (CAD/ | Calorific Value | intensity |
| Fuel¹⁸* | GJ) | (MJ/kg)** | (kg CO₂/GJ) |
| Hard coal | 2.05¹⁹ | 26.62 | 96 |
| Natural gas | 4.2*** | 47.1 | 56.1 |
| Hydrogen | 16.7**** | 120 | 0.005²⁰ |

*Values taken from ref¹⁸ unless specified otherwise
**Equal to Lower Heating Value (LHV; https://chemeng.queensu.ca/courses/CHEE332/files/ethanol_heating-values.pdf)
***Government of Alberta, Canada (Natural Gas Reference Price, https://www.alberta.ca/alberta-natural-gas-reference-price.aspx, Accessed Dec. 12, 2022)
****Equivalent to $2 USD/kg

### Calculation of Production Cost

The breakeven production cost for each pathway was calculated based on the operating (OPEX) and capital costs (CAPEX) for a cement plant with a 3000 t_{cement} per day capacity containing either a OER or HOR electrolyser unit in place of a precalciner. The total plant cost was amortized over a 30 year period based on a set of widely used assumptions listed in Table 1. The inventors approximated the CAPEX for each pathway by subtracting the cost of the precalciner from the cost of a reference plant (CAPEX_{ref}) and replacing this sum with the cost of either a OER or HOR electrolyser unit. The CAPEX of OER or HOR electrolyser units were calculated using the Department of Energy (DOE) H2A cost model. The OPEX for each pathway was divided into fixed and variable costs. Fixed operating costs (OPEX_{fixed}) include the cost of mineral feedstocks, labour, insurance, maintenance, and tax. Conversely, the variable operating cost (OPEX_{variable}) includes the cost of electricity, kiln fuels, carbon emissions (i.e., a carbon tax), and H₂O or H_{2(g)} for the anodic reaction. The emissions intensity of electricity generation also affects the production cost due to the incorporation of a carbon tax which we applied to both Scope 1 and Scope 2 emissions. The inventors calculated the unit and monthly cost of water using a water rent estimator for commercial businesses provided by the Government of British Columbia (see Table 1 for details). The cost of H_{2(g)} for the HOR pathway was assumed to be fixed at $2/kgH₂ based on DoE cost models and targets. For each pathway the inventors calculated the breakeven production cost in two scenarios to represent current market conditions ($0.05/kWh, 0.15 kg CO₂/kWh, $50/tCO₂), and an optimistic scenario with inexpensive solar electricity and carbon pricing that aligns with US legislation ($0.02/kWh, 0.04 kg CO₂/kWh, $85/t_{CO2}).

### Sensitivity Analysis

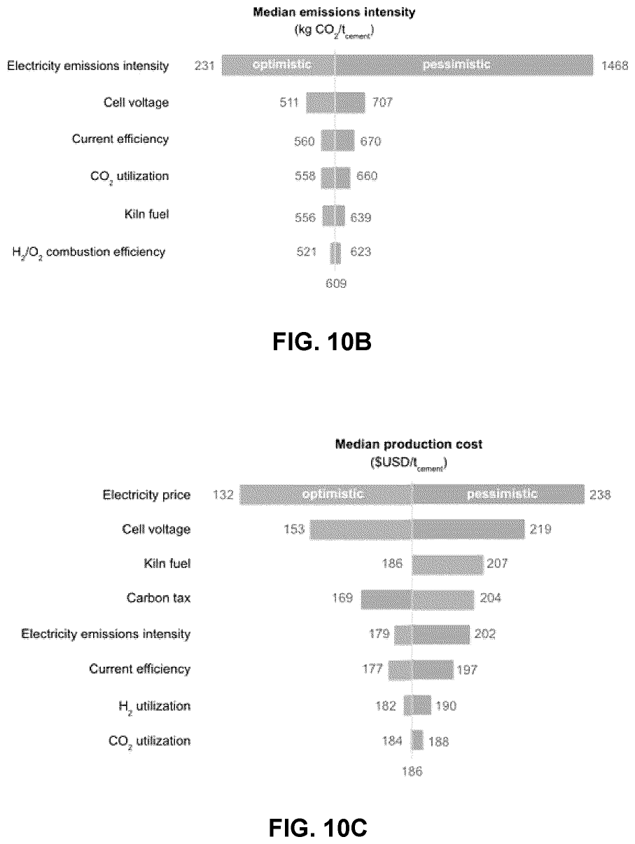

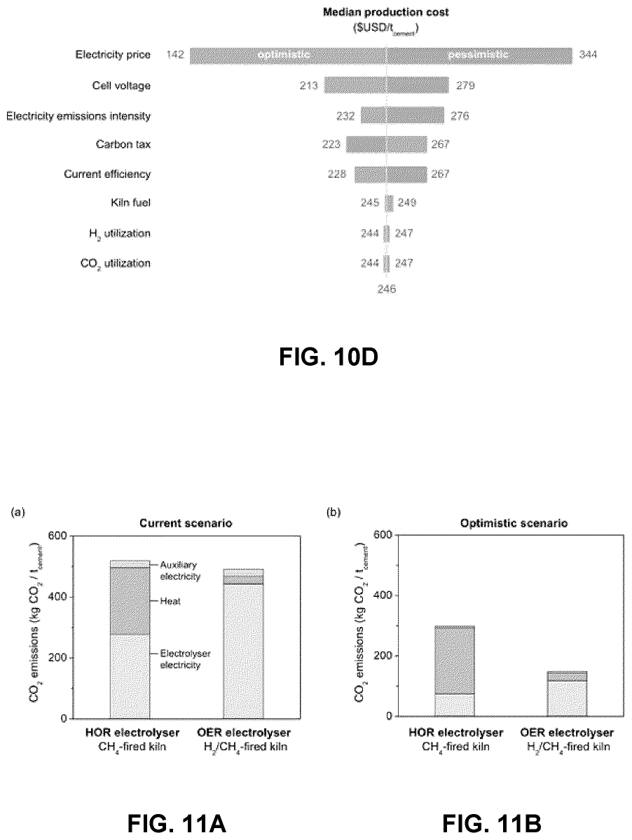

The inventors performed a one-factor sensitivity analysis for the CO₂ emissions intensity and breakeven production cost of electrochemical cement production involving HOR and BPM electrolysers. These analyses varied key performance metrics for HOR and BPM electrolysers, and factors related to the cost and carbon intensity of electricity, kiln fuels, and emitted CO₂. The parameters used in the analysis are listed in Table 3 and the resulting tornado plots are shown in FIGS. 10-13.

TABLE 3
Parameters for life-cycle and cost analysis of
electrochemical and thermal cement production

| | Pessimistic | Median | Optimistic |
|---|---|---|---|
| Electrolyser | | | |
| performance metrics | | | |
| Voltage (V) (OER/HOR) | 6/3.5 | 5/2.5 | 4/1.5 |
| Current efficiency (%) | 80 | 90 | 100 |
| CO₂ utilization (%) | 80 | 90 | 100 |
| Current density (A cm⁻²) | 0.10 | 0.50 | 1 |
| Energy and emissions factors | | | |
| Electricity cost ($/kWh) | 0.10 | 0.05 | 0.02 |
| Grid emissions intensity | 0.04 | 0.15 | 0.10 |
| (kg CO₂/kWh) | | | |
| Carbon tax ($/tonne CO₂) | 0 | 50 | 100 |
| H₂ combustion efficiency (%) | 60 | 70 | 80 |
| Kiln fuel | Coal | CH₄ | H₂ |

### Analysis

The use of hydrogen oxidation to generate protons for CaCO₃₍ₛ₎ decomposition decreases the energy consumption of the HOR electrolyser relative to the OER electrolyser. This analysis assumes that HOR and OER electrolysers operate at 500 mA cm⁻² with cell voltages of 2.5 V and 5 V, respectively. These estimates are based on metrics reported in this work and the current-voltage characteristics of similar electrochemical devices. The difference in cell voltage between OER and HOR electrolysers decreases the electrical energy consumption from 11.2 to 7.2 GJ_{electric}/t_{cement}. Referring to FIG. 9B, in the OER pathway, the electrolyser consumes >90% of the total energy demand (11.6 GJ/t_{cement}), provided that combustion of the H_{2(g)} byproduct is used to heat the Ca(OH)_{2(g)}-fed kiln. Combustion of the H_{2(g)} stream with 80% efficiency would generate 2.52 GJₜₕₑᵣₘₐₗ of the 2.96 GJₜₕₑᵣₘₐₗ/t_{cement} required to heat the Ca(OH)₂₍ₛ₎-fed kiln. The inventors assume that the remaining 0.44 GJₜₕₑᵣₘₐₗ is sourced from the combustion of natural gas (NG).

For the HOR pathway (FIG. 9B), the inventors assume that the Ca(OH)₂₍ₛ₎-fed kiln is heated solely using NG while the H_{2(g)} is recirculated to the anode for the HOR. Despite the additional fuel requirement, the HOR pathway has a slightly lower total energy demand (10.2 GJ/t_{cement}) than the OER pathway (11.6 GJ/_{cement}) due to the lower cell voltage afforded by the HOR.

The use of the H_{2(g)} byproduct for the HOR decreases the energy consumption of the HOR electrolyser but increases the emissions intensity of cement production. The emissions intensity of the HOR pathway (520 kg CO₂/t_{cement}) is ca. 10% higher than the OER pathway (491 kg CO₂/t_{cement}). The lower emissions intensity of the OER pathway is due to the use of H_{2(g)} as a carbon-neutral kiln fuel. Therefore, the majority of the emissions in this pathway arise from electricity generation.

FIG. 11A is a graph showing the CO₂ emissions intensities for electrochemical cement production with HOR and OER electrolyzers calculated to represent current market conditions ($0.05/kWh, 0.15 kg CO₂/kWh). FIG. 11B is a graph showing the CO₂ emissions intensities for electrochemical cement production with HOR and OER electrolyzers calculated to represent an optimistic scenario with inexpensive solar electricity ($0.02/kWh, 0.04 kg CO₂/kWh).

The emissions intensity of the HOR pathway includes emissions from both electricity generation and NG combustion, which contributes 219 kg CO₂/t_{cement}. The proportion of Scope 2 emissions from electricity generation in both pathways suggests that the overall emissions intensities are sensitive to the emissions intensity of electricity generation. Accordingly, the emissions intensities of HOR and OER pathways are decreased to 291 kg CO₂/t_{cement} and 149 kg CO₂/t_{cement}, respectively, when the levelized cost and emissions intensity of solar electricity generation are used in the model (Table 4, FIG. 11B). These values correspond to a >65% reduction in the carbon intensity of cement manufacturing compared to the reference thermal process (820 kg CO₂/t_{cement}). Moreover, the emissions intensities of HOR and OER pathways are lower than emissions targets set by multinational cement manufacturers (e.g., LafargeHolcim, 475 kg CO₂/t_{cement} by 2030).

TABLE 4
Manipulated parameters in
techno-economic analysis scenarios

| Parameter | Current | Optimistic |
|---|---|---|
| Electricity price ($/kWh) | 0.05 | 0.02 |
| Grid emissions intensity | 0.15 | 0.04 |
| (kg CO₂/kWh) | | |
| Carbon price ($/tonne CO₂) | 50 | 85 |

The production cost calculated for each pathway consists of the capital cost (CAPEX) and operating cost (OPEX) for a hypothetical cement plant containing a cement electrolyser in place of a precalciner. The inventors approximated the CAPEX by subtracting the cost of the precalciner from the cost of a reference cement plant (CAPEX_{ref}) and replacing this sum with the cost of either a OER or HOR electrolyser. The CAPEX of cement electrolysers was calculated using the Department of Energy (DOE) H2A cost model for water electrolysers. The inventors believe that this established cost model is appropriate for a first-order CAPEX approximation because the architecture of cement electrolysers is similar to water electrolysers. The OPEX for each pathway is divided into fixed and variable costs. Fixed operating costs (OPEX_{fixed}) include the cost of mineral feedstocks, labour, insurance, maintenance, and tax. Variable costs (OPEX_{variable}) include electricity, fuels, carbon emissions (i.e., a carbon tax), and H₂O or H_{2(g)} for the anodic reaction. For each pathway the inventors calculated the breakeven production cost in two scenarios (Table 2) to represent current market conditions and an optimistic scenario which reflects electricity sourced from modern solar energy installations and carbon pricing consistent with United States legislation ($85/t_{CO2}).

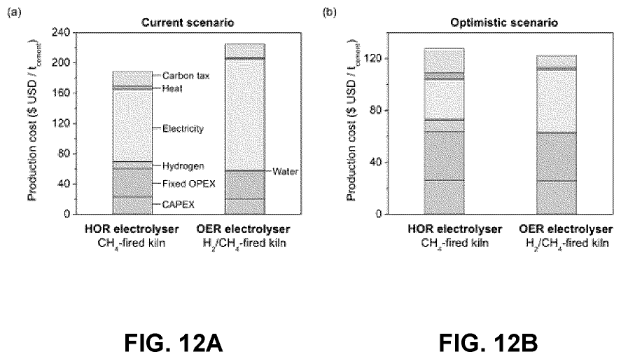

FIG. 12A is a graph illustrating the production cost for electrochemical cement production with HOR or OER electrolysers, in which the production cost is calculated based on current market conditions ($0.05/kWh, 0.15 kg CO₂/kWh, $50/t_{CO2}). FIG. 12B is a graph illustrating the production cost for electrochemical cement production with HOR or OER electrolysers, in which the production cost is calculated based on an optimistic scenario with inexpensive solar electricity and progressive carbon pricing ($0.02/kWh, 0.04 kg CO₂/kWh, $85/t_{CO2}). Production costs represent the sum of capital costs (CAPEX) and operating costs (OPEX). Fixed OPEX include the cost of mineral feedstocks, labour, insurance, maintenance, and tax.

The largest expense in the current scenario for both OER and HOR pathways is the cost of electricity (FIG. 12A). At a fixed price of $0.05/kWh, the cost of electricity amounts to ca. $150/t_{cement} for the OER pathway and $95/t_{cement} for the HOR pathway. This expense alone results in a lower production cost for the HOR pathway compared to the OER pathway ($189 vs. $225/t_{cement}), despite the added costs of NG for heating the kiln and H_{2(g)} for the anode reaction. The total amount of H_{2(g)} required at the anode of HOR electrolysers amounts to $44.4/t_{cement} (at a purchase price of $2/kgH₂), however, the inventors assume that an optimized system can source 80% of this H_{2(g)} by recirculating the stream generated at the cathode. The CAPEX and OPEX_{fixed} are roughly equal between the two pathways and contribute roughly $50/t_{cement} to the total production cost (FIG. 12A).

The production cost of OER and HOR pathways are nearly equivalent in the optimistic scenario which reflects the electricity price and emissions intensity of modern solar installations (FIG. 12B). The low electricity price ($0.02/kWh) markedly decreases the electricity cost of the OER pathway to $48/t_{cement} and decreases the total production cost to $122/t_{cement}. The production cost of the HOR pathway is nominally higher ($123/t_{cement}) than the OER pathway, due in part to the increased carbon pricing which penalizes the more emissions-intensive process. These production costs are on the order of production costs calculated for the standard thermal process ($120/t_{cement}). This analysis indicates that electrochemical cement production using an electrolyser to convert CaCO₃₍ₛ₎ into Ca(OH)₂₍ₛ₎ is a viable path for decarbonizing cement production and can be cost-competitive with the incumbent process.

### Example 2—OER Electrolyzer

An OER electrolyer illustrated in FIG. 1B and the method of performing electrolysis illustrated in FIGS. 5A and 4B were used to convert calcium carbonate to calcium hydroxide. In the example embodiment, anode 20 and cathode 18 each comprises a free-standing nickel foam with an active area of 2.25 cm³. First membrane 28 is bipolar membrane commercially available under the product name Fumasep FBM. First membrane 28 has a thickness of 195 μm. Second membrane 30 is an ion exchange membrane commercially available under the product name Nafion™ 117. Second membrane 30 has a thickness of 175 μm. The first hydrogen-containing reactant used in this example embodiment is 1.0 KOH. The second hydrogen-containing reactant is water. The catholyte used is 1.0 M KCl. The CaCO₃ is supplied as an aqueous slurry. 2 g of CaCO₃ is suspended in 100 ml 0.2M CaCl₂) solution.

The electrolysis experiments were conducted in the three-compartment cement electrolyzer illustrated in FIG. 1B. A peristaltic pump was used to deliver 1.0 M KOH to anode chamber 24 at a constant flow rate of 20 ml min⁻¹. An aqueous slurry of CaCO₃₍ₛ₎ microparticles (0.02 g mL⁻¹; ˜ 3 μm diameter) in 0.2 M CaCl₂) (aq) was fed to chemical compartment 26 at a rate of 40 mL min⁻¹. A 1.0 M KCl solution was delivered to cathode compartment 22 at a rate of 20 ml min⁻¹. Nickel foam was used for both the anode and cathode (active area 2.25 cm²). In situ CO_{2(g)} formation from chemical compartment 26 was measured using an in-line gas chromatograph (GC) while the cell voltage (V_{cell}) and current density (J) were each recorded using a potentiostat over the course of the electrolysis experiments. The Ca(OH)₂₍ₛ₎ precipitate produced in the cathode compartment was collected after electrolysis and characterized by X-ray powder diffraction (XRD) and Fourier-transform infrared spectroscopy (FTIR).

### 2.1—CaCO₃ Particle Characterization

Electrolysis was performed at 45 mA cm⁻² using the OER electrolyzer while tracking the change in CaCO₃₍ₛ₎ particle size using scanning electron microscopy (SEM) and dynamic light scattering (DLS) techniques.

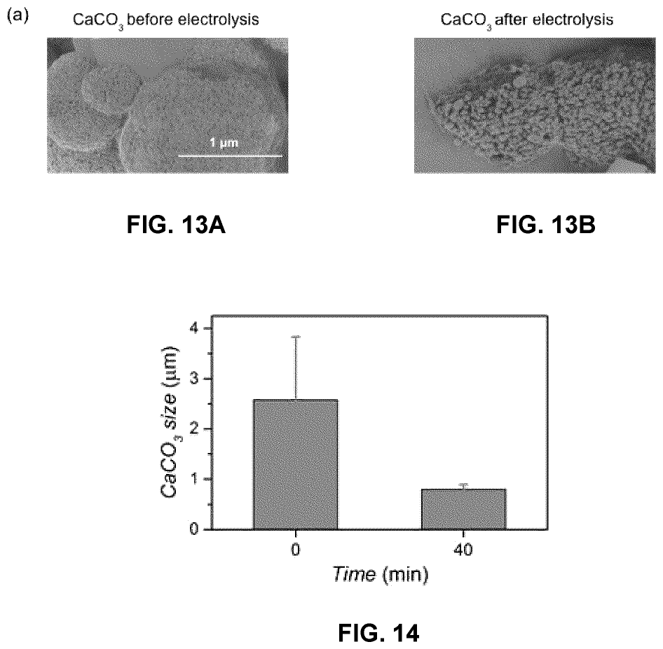

FIG. 13A is an SEM image of the CaCO₃ particles before electrolysis at 45 mA cm⁻² using an OER electrolysis. FIG. 13B is an SEM image of the CaCO₃₍ₛ₎ particles after electrolysis. The SEM images of the CaCO₃₍ₛ₎ particles after electrolysis showed higher porosities consistent with the partial consumption of CaCO₃₍ₛ₎ during electrolysis.

FIG. 14 is a plot of CaCO₃₍ₛ₎ size (μm) as measured by dynamic light scattering (DLS) techniques as a function of time (min) during electrolysis at 45 mA cm⁻² using an OER electrolyzer. DLS measurements confirmed that the average diameter of the CaCO₃₍ₛ₎ particles decreased from 2.6±1.3 μm to 0.8±0.1 μm after 40 minutes of electrolysis.

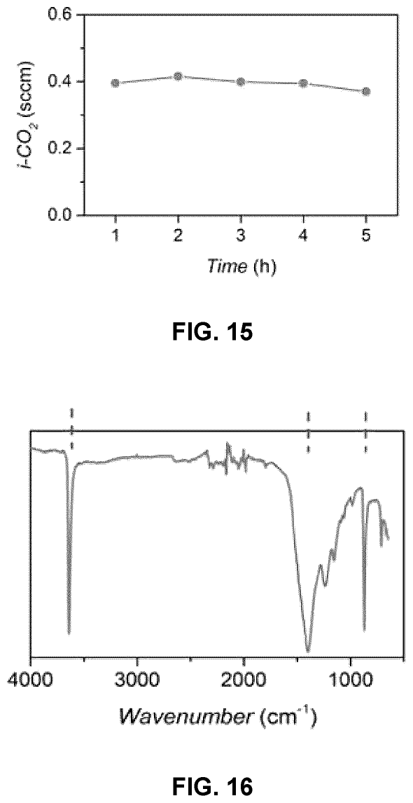

FIG. 15 is a plot of the rate of CO₂ formation [i-CO₂ (g)] as a function of time (h) during electrolysis for 5 hours at 45 mA cm⁻² using a OER electrolyzer. The rate of CO_{2(g)} generation is measured to confirm that CaCO₃₍ₛ₎ was decomposed into Ca²⁺ and CO_{2(g)}.

Results show that CO_{2(g)} was released from the chemical compartment at a rate of 0.4 standard cubic centimeters per minute (sccm). This value decreased by 8% after 5 h of electrolysis, consistent with the consumption of the CaCO₃₍ₛ₎ reactant over time. A current efficiency for the system of 57% was calculated by comparing the rate of CO_{2(g)} formation against the theoretical H+ flux from the BPM.

The white precipitate in the cathode compartment was collected and dried before characterization by X Ray Diffraction (XRD).

FIG. 16 is a Fourier-transform infrared spectroscopy (FTIR) graph of the produced Ca(OH)₂ collected after electrolysis at 45 mA cm⁻² using an OER electrolyzer.

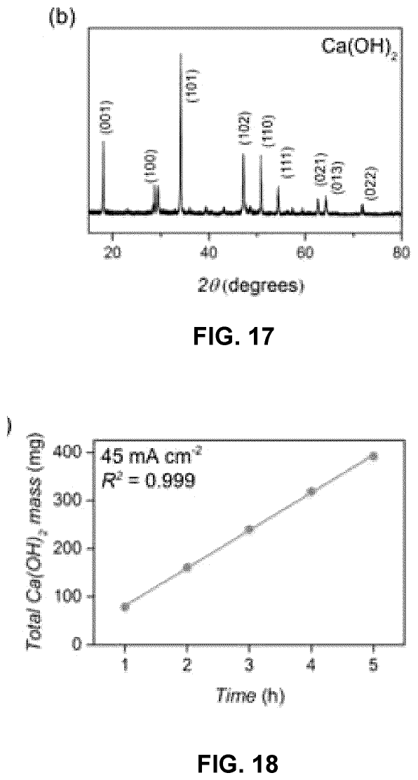

FIG. 17 is a X Ray Diffraction (XFD) pattern of the Ca(OH)₂₍ₛ₎ precipitate collected from the cathode compartment after 5 hours of electrolysis at 45 mA cm⁻² using an OER electrolyzer. The XRD pattern confirmed that the precipitate was predominantly Ca(OH)₂₍ₛ₎ with minimal CaCO₃₍ₛ₎ impurity.

It was not possible to gravimetrically quantify Ca(OH)₂₍ₛ₎ produced in the cathode compartment (2.25 cm²) due to adhesion of Ca(OH)₂₍ₛ₎ particles to the Nafion membrane. Ca(OH)₂₍ₛ₎ production was quantified by assuming that the rate of in situ CO_{2(g)} generation is equal to the rate of Ca(OH)₂₍ₛ₎ formation in accordance with the 1:1 stoichiometry. That is, for every 1 mole of CO_{2(g)} produced, 1 mole of Ca²⁺ is transported across the membrane to form Ca(OH)₂₍ₛ₎ in the cathode compartment. With this procedure, the inventors determined the Ca(OH)₂₍ₛ₎ production rate to be 78.4 mg h⁻¹ at 45 mA cm⁻² (R²=0.999; FIG. 18).

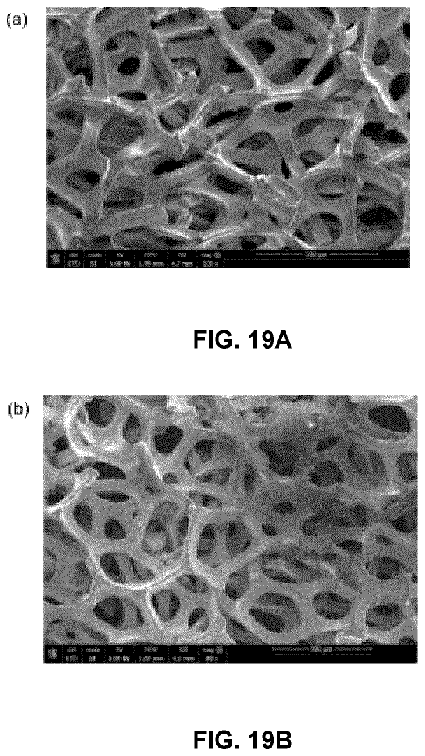

Over 5 hours of electrolysis at 45 mA cm⁻², the cell voltage increased from 6.3 to 7.2 V. The inventors believe that H_{2(g)} bubble formation and convective fluid flow in the cathode compartment largely mitigated Ca(OH)₂₍ₛ₎ from accumulating on the cathode. FIGS. 19A and 19B are scanning electron microscopy images of the Nickel foam cathode before and after electrolysis respectively. As shown in FIG. 19B, some Ca(OH)₂₍ₛ₎ were found to remain on the electrode surface after electrolysis. The inventors predict that periodic removal of the Ca(OH)₂₍ₛ₎ precipitate may be required to maintain high catalytic activities and energy efficiencies.

### 2.2—Electrolyzer Energy Consumption

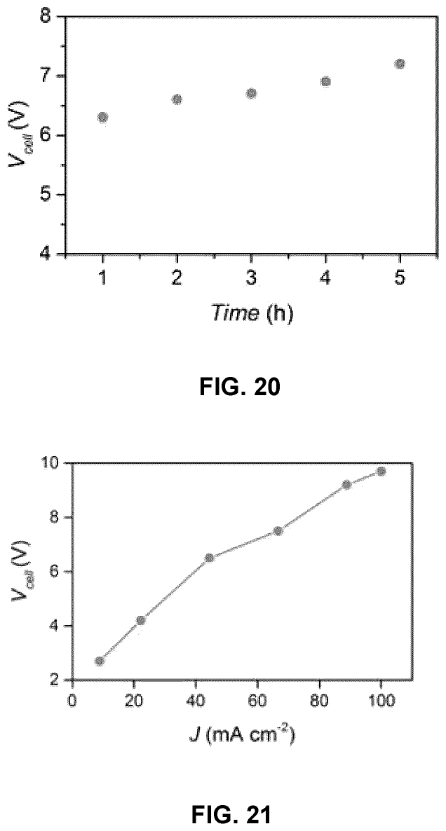

FIG. 20 is a plot of cell voltage (V_{cell}) as a function of electrolysis time (h) at 100 mA. Results show that the V_{cell} increased from 6.3 to 7.2 V during 5 h of electrolysis at 100 mA due to a reduction in catalyst surface area.

FIG. 21 is a plot of cell voltage (V_{cell}) as a function of current densities (J mA cm⁻²). Electrolysis was performed at current densities from 10 to 100 mA cm⁻² to determine the electrolyzer energy consumption. The electrolyzer required voltages as high as 9.7 V for electrolysis at 100 mA cm⁻² due to the large distance (1.5 cm) and correspondingly high ohmic losses between the cathode and anode.

### 2.3—Purity of CO₂ gas

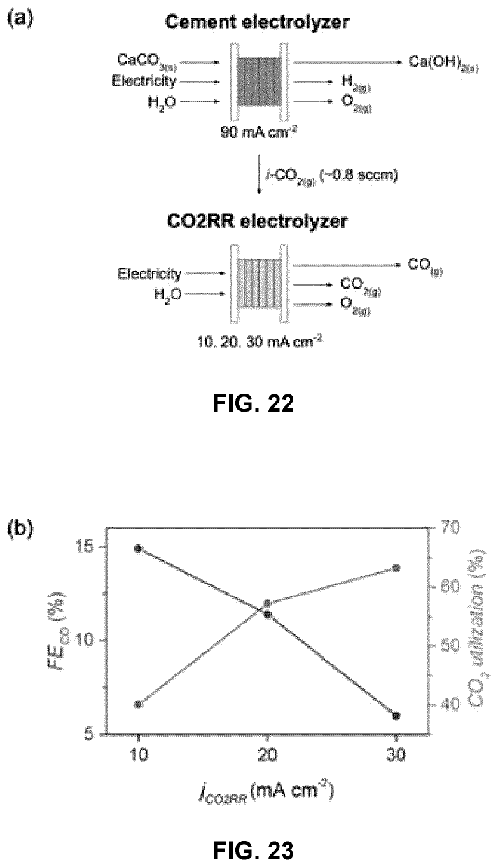

The inventors believe that CO_{2(g)} released during CaCO₃₍ₛ₎ decomposition is pure and not contaminated with H_{2(g)} and O_{2(g)} from electrolysis using the OER electrolyzer. CO_{2(g)} was supplied to a CO₂RR electrolyzer (as illustrated schematically in FIG. 22). The CO₂RR electrolyzer used in this experiment comprises a composite Ag/carbon cathode, a Ni foam anode, and an anion-exchange membrane (Sustainion®). The cathode of the CO₂RR electrolyzer was fed with the CO_{2(g)} generated by the OER electrolyzer at 90 mA cm⁻² (˜0.8 sccm), while the anode was fed with 10 mM KHCO₃ at 40 ml min⁻¹. The concentrations of gaseous CO₂, H₂ and CO were analyzed at the inlet and outlet of the CO₂RR electrolyzer using a GC.

Results show that 63% of CO_{2(g)} released from the OER electrolyzer is converted into CO_{(g)} by the CO₂RR electrolyzer operating at 30 mA cm⁻². This result shows how a tandem electrolyzer system may be used to abate the majority of CO_{2(g)} emissions during electrochemical cement clinker production.

### 2.3—Methods

K₂CO₃, CaCl₂ and CaCO₃₍ₛ₎ (Sigma Aldrich, USA) were purchased and used as received. Fumasep FBM bipolar membranes (BPMs), and Nafion PFSA NR-212 were purchased from Fuel Cell Store (USA). The BPMs were stored in 1 M NaCl and the Nafion membranes were stored in 1 M KOH prior to use. The nickel foams (purity >99.99%) were purchased from MTI corporation. For the gas-fed CO₂RR electrolyzer, silver nanoparticles (100 nm) were purchased from Millipore-Sigma. Anion exchange membrane Sustainion® X37-50 Grade RT membrane was purchased from Dioxide Materials. A CH instrument 660D potentiostat (USA) equipped with an Amp booster was used for all electrolysis experiments. A gas chromatography instrument (GC; Perkin Elmer, Clarus 580), equipped with a packed MolSieve 5 Å column and a packed HayeSepD column was used to detect CO_{2(g)}, CO_{(g)} and H_{2(g)} using a flame ionization detector (FID) and a thermal conductivity detector (TCD), respectively. The concentrations of the products CO_{2(g)}, CO_{(g)} and H_{2(g)} (ppm) in the headspace of the catholyte reservoir were quantified by calibrating the signal area for CO_{2(g)}, CO_{(g)} and H_{2(g)} to known concentrations of the three gases.

### Electrode Preparation

The nickel foam was cut into the desired dimension (2×2 cm) with a blade and washed with acetone and water. To fabricate traditional gas diffusion electrodes (GDEs) with silver nanoparticles, a catalyst ink was prepared by mixing 315 mg silver nanoparticles, 15 ml DI water, 15 ml IPA and 420 μl Nafion® 117 solution. The catalyst ink was then spray-coated on the carbon cloth to make multiple GDEs, and each GDE (geometric area: 4 cm²) has silver loadings of 3.7±0.1 mg cm⁻².

### Electrolysis

For the cement electrolysis, a peristaltic pump was used to deliver 1.0 M KOH to the anode of the cement electrolyzer at a constant flow rate of 20 ml min-1. 2 g CaCO₃₍ₛ₎ was added into a 100 ml 0.2 M CaCl₂) solution, and the suspension was delivered into the chemical compartment at a constant flow rate of 40 ml min-1. 1.0 M KCl was delivered to the cathode of the cement electrolyzer (active window area 2.25 cm²) at a constant flow rate of 20 ml min⁻¹. Polytetrafluoroethylene (PTFE) gaskets were placed between electrode and membrane to prevent leakage. CO_{2(g)} in the headspace of the cathode electrolyte reservoir was delivered to an in-line gas chromatograph (GC) for quantification at different time scales, or to a CO₂RR electrolyzer for reaction. The actual flow rate of the gas mixture was measured by a flow meter positioned downstream of the GC.

For the CO_{2(g)} electrolysis, a peristaltic pump was used to deliver 10 mM KHCO₃ to the anode of the CO₂RR electrolyzer at a constant flow rate of 40 ml min⁻¹ CO_{2(g)} produced from the cement electrolyzer was directly delivered to the cathode of the CO₂RR electrolyzer with 5 sccm N₂ as the carrier gas. The membrane electrode assembly (MEA) consists of a nickel foam anode (2.5×2.5 cm), a Sustainion® membrane (3×3 cm) and a Ag catalyst ink deposited on a carbon paper GDL cathode (2×2 cm). Two PTFE gaskets were placed separately between the anode and anodic flowplate, and the cathode and cathodic flowplate to prevent leakage. Gaseous products were delivered to an in-line gas chromatograph (GC) for quantification at 300 s.

### Faradaic Efficiency Calculation

The inventors measured the FE_{CO} at constant current densities (10, 20, and 30 mA cm⁻²) by quantifying the H₂ and CO concentrations (for calculating mole fraction of CO in the gaseous mixture analyzed, x) using a GC. The FE of a gaseous product k was determined in accordance with Eq. B1:

$${FE}_{k} = \frac{{n}_{k} F {χ}_{k} {F}_{m}}{I} \qquad Eq . B1$$

Where nₖ is the number of electrons exchanged, F is Faraday's constant (F=96,485 C/mol), Fm is the molar flow rate in mol/s, and I is the total current in A. The molar flow rate is derived from the volume flow rate Fv by the relation Fₘ=pFᵥ/RT, with p being the atmospheric pressure in Pa, R the ideal gas constant of 8.314 J/mol K, and T the temperature in K. No liquid products were detected by 1H NMR. Therefore, the FE_{CO} and FE_{H2} were normalized to 100% for every experiment.

### CO₂ Utilization Calculation

CO₂ utilization was calculated in accordance with Eq. B2. This quantity represents the conversion of in-situ generated CO₂ into CO, and therefore, the extent to which the CO is diluted with unreacted CO₂.

$${CO}_{2} utilization = \frac{[ CO ]}{[ {CO}_{2} ] outlet + [ CO ]} \% \qquad Eq . B2$$

Where [CO] and [CO2]ₒᵤₜₗₑₜ represent the concentrations of CO and CO₂ in the catholyte headspace as measured by in-line GC analysis.

### Energy Analysis

The focus of the energy analysis is an electrolyzer system producing Ca(OH)₂ precursor, or a thermal cement plant using CaO as a precursor to produce 100 ton/day of 3CaO·SiO2 from using CaCO₃ as the feedstock. The purpose of the energy analysis is to determine the energy consumption of the electrolytic Ca(OH)₂ production and thermal CaO production. The inventors used experimental input parameters for the cement electrolyzer (Table 5). The thermal energy efficiency was chosen to be 60% for both pathways. The full cell voltage was taken as 3 volts at 10 mA cm⁻² for the OER electrolyzer. An optimistic 95% current efficiency at that current density was assumed, because the real current efficiency cannot be measured due to the ultralow [i-CO₂].

The total electrode area was determined directly based on the Ca(OH)₂ product formation rate and the actual Ca(OH)₂ production rate at cathode per unit area (Eq. B3)

$${S}_{electrode} = \frac{requried Ca ( OH ) 2 production rate}{unit Ca ( OH ) 2 formation rate at cathode} \qquad Eq . B3$$

Therefore, a total electrode area of 10321 m² was calculated for the electrode area values. Power consumption was calculated using the voltage and current of the electrolyzer (Eq. B4),

$$Power = J \times {S}_{electrode} \times {V}_{cell} \qquad Eq . B4$$

During the Ca(OH)₂ production, H₂ and O₂ are co-produced at cathode and anode respectively. The inventors assumed that H₂/O₂ can be used as an energy supply to compensate for the overall electrical energy. Therefore, the energy consumption for electrolytic per mol Ca(OH)₂ production step is after subtracting H₂/O₂ energy.

TABLE 5
Input and output parameters from the energy
analysis of the electrolytic Ca(OH)₂ production.
Electrolytic Ca(OH)₂ production

| | |
|---|---|
| Input parameters | |
| 3CaO•SiO₂ production rate | 100 |
| (tonnes/day) | |
| CaCO₃ production rate | 43.86 |
| (tonnes/day) | |
| Voltage (V) | 3 |
| J (mA cm⁻²) | 10 |
| Current efficiency (%) | 95 |
| Thermal efficiency (%) | 60 |
| Output parameters | |
| Electrode area (m²) | 10312 |
| Electrolyzer power (MW) | 3.09 |
| Electricity consumption | 8.23 |
| (MJ/kg Ca(OH)₂) | |
| H₂/O₂ compensated energy | 3.85 |
| (MJ/kg Ca(OH)₂) | |
| Total Energy | 4.38 |
| consumption (MJ/kg | |
| Ca(OH)₂) | |
| Total Energy | 324 |
| consumption (KJ/mol | |
| Ca(OH)₂) | |

*The current efficiency at 10 mA cm⁻² is difficult to measure due to the ultra low value of CO2 concentration, so we used an optimistic value of 95% for the calculations.

TABLE 6
Input and output parameters from the energy
analysis of the thermal CaO production.
Thermal CaO production

| | |
|---|---|
| Input parameters | |
| 3CaO•SiO₂ production rate | 100 |
| (tonnes/day) | |
| CaCO₃ production rate | 43.86 |
| (tonnes/day) | |
| Thermodynamic energy | 176 |
| (KJ/mol CaCO₃) | |
| Thermal efficiency (%) | 60 |
| Output parameters | |
| Total Energy | 293 |
| consumption (KJ/mol | |
| CaO) | |

### Example 3—Production of Ion Exchange Membrane Adapted to Block Calcium Ion (Ca²⁺)

Nafion™ membranes were conditioned in HCl for 1 hour. The membrane modifications were performed in a beaker containing the reagents, leading to a two-face modification. The protons of the commercial membrane were first ion-exchanged with protonated aniline using a 1-10 vol % aniline in 1 M HCl aqueous solution. After rinsing, the beaker was then filled with a 0.1-1 M k2S2O8 aqueous solution to induce the polymerization. The polymerization time was 1 h. The membranes were stored in 1 M HCl for more than 24 h prior to characterization in order to ensure the protonation of the polyaniline (PANI) layer.

The following documents describe related technologies. Embodiments of the present technology may incorporate features as described in these references. All of the following references are hereby incorporated herein by reference as if fully set forth herein for all purposes.
Friedlingstein, P.; O'Sullivan, M.; Jones, M. W.; Andrew, R. M.; Gregor, L.; Hauck, J.; Le Quere, C.; Luijkx, I. T.; Olsen, A.; Peters, G. P.; Peters, W.; Pongratz, J.; Schwingshackl, C.; Sitch, S.; Canadell, J. G.; Ciais, P.; Jackson, R. B.; Alin, S. R.; Alkama, R.; Arneth, A.; Arora, V. K.; Bates, N. R.; Becker, M.; Bellouin, N.; Bittig, H. C.; Bopp, L.; Chevallier, F.; Chini, L. P.; Cronin, M.; Evans, W.; Falk, S.; Feely, R. A.; Gasser, T.; Gehlen, M.; Gkritzalis, T.; Gloege, L.; Grassi, G.; Gruber, N.; Gürses, Ö.; Harris, I.; Hefner, M.; Houghton, R. A.; Hurtt, G. C.; lida, Y.; Ilyina, T.; Jain, A. K.; Jersild, A.; Kadono, K.; Kato, E.; Kennedy, D.; Klein Goldewijk, K.; Knauer, J.; Korsbakken, J. I.; Landschutzer, P.; Lefevre, N.; Lindsay, K.; Liu, J.; Liu, Z.; Marland, G.; Mayot, N.; McGrath, M. J.; Metzl, N.; Monacci, N. M.; Munro, D. R.; Nakaoka, S.-I.; Niwa, Y.; O'Brien, K.; Ono, T.; Palmer, P. I.; Pan, N.; Pierrot, D.; Pocock, K.; Poulter, B.; Resplandy, L.; Robertson, E.; Rödenbeck, C.; Rodriguez, C.; Rosan, T. M.; Schwinger, J.; Seferian, R.; Shutler, J. D.; Skjelvan, I.; Steinhoff, T.; Sun, Q.; Sutton, A. J.; Sweeney, C.; Takao, S.; Tanhua, T.; Tans, P. P.; Tian, X.; Tian, H.; Tilbrook, B.; Tsujino, H.; Tubiello, F.; van der Werf, G. R.; Walker, A. P.; Wanninkhof, R.; Whitehead, C.; Willstrand Wranne, A.; Wright, R.; Yuan, W.; Yue, C.; Yue, X.; Zaehle, S.; Zeng, J.; Zheng, B. Global Carbon Budget 2022. Earth Syst. Sci. Data 2022, 14 (11), 4811-4900.
Chen, C.; Xu, R.; Tong, D.; Qin, X.; Cheng, J.; Liu, J.; Zheng, B.; Yan, L.; Zhang, Q. A Striking Growth of CO₂ Emissions from the Global Cement Industry Driven by New Facilities in Emerging Countries. Environ. Res. Lett. 2022, 17 (4), 044007.
Ellis, L. D.; Badel, A. F.; Chiang, M. L. Toward Electrochemical Synthesis of cement—An Electrolyzer-Based Process for Decarbonating CaCO3 While Producing Useful Gas Streams. Proceedings of the 2020.
Zhang, Z.; Mowbray, B. A. W.; Parkyn, C. T. E.; Waizenegger, C. T. E.; Williams, A. S. R.; Lees, E. W.; Ren, S.; Kim, Y.; Jansonius, R. P.; Berlinguette, C. P. Cement Clinker Precursor Production in an Electrolyser. Energy Environ. Sci. 2022.
Yarmuth, J. A. Inflation Reduction Act of 2022; 2022.
Salvatore, D.; Berlinguette, C. P. Voltage Matters When Reducing CO2 in an Electrochemical Flow Cell. ACS Energy Letters.
Ripatti, D. S.; Veltman, T. R.; Kanan, M. W. Carbon Monoxide Gas Diffusion Electrolysis That Produces Concentrated C2 Products with High Single-Pass Conversion. Joule 2019, 3 (1), 240-256.
Bui, J. C.; Digdaya, I.; Xiang, C.; Bell, A. T.; Weber, A. Z. Understanding Multi-Ion Transport Mechanisms in Bipolar Membranes. ACS Appl. Mater. Interfaces 2020, 12 (47), 52509-52526.
Objectives, F. Y. 2016. V.D.1 High Performance, Durable, Low Cost Membrane Electrode Assemblies for Transportation Applications. https://www.hydrogen.energy.gov/pdfs/progress16/v_d_1_steinbach_2016.pdf (accessed 2022 Nov. 7).
Asdrubali, F.; Baldinelli, G.; D'Alessandro, F.; Scrucca, F. Life Cycle Assessment of Electricity Production from Renewable Energies: Review and Results Harmonization. Renewable Sustainable Energy Rev. 2015, 42, 1113-1122.
Kim, H. C.; Fthenakis, V.; Choi, J.-K.; Turney, D. E. Life Cycle Greenhouse Gas Emissions of Thin-Film Photovoltaic Electricity Generation. J. Ind. Ecol. 2012, 16, S110-S121.
Cole, W.; Frew, B.; Gagnon, P.; Reimers, A.; Zuboy, J.; Margolis, R. Envisioning a Low-Cost Solar Future: Exploring the Potential Impact of Achieving the SunShot 2030 Targets for Photovoltaics. Energy 2018, 155, 690-704.
Zhongming, Z.; Linong, L.; Xiaona, Y.; Wangqiang, Z.; Wei, L.; Others. LafargeHolcim Signs Net Zero Pledge with Science-Based Targets. 2020.
Steward, D.; Ramsden, T.; Zuboy, J. H2A Central Hydrogen Production Model, Version 3 User Guide. National Renewable Energy Laboratory (NREL) 2012.
Shen, K.-Y.; Park, S.; Kim, Y.-B. Hydrogen Utilization Enhancement of Proton Exchange Membrane Fuel Cell with Anode Recirculation System through a Purge Strategy. Int. J. Hydrogen Energy 2020, 45 (33), 16773-16786.
Tanpure, S.; Ghanwat, V.; Shinde, B.; Tanpure, K.; Lawande, S. The Eggshell Waste Transformed Green and Efficient Synthesis of K-ca (OH)₂ Catalyst for Room Temperature Synthesis of Chalcones. Polycycl. Aromat. Compd. 2022, 42 (4), 1322-1340.
Voldsund, M.; Anantharaman, R.; Berstad, D.; Fu, C. D4. 6: CEMCAP Comparative Techno-Economic Analysis of CO2 Capture in Cement Plants.: CO2 Capture from Cement.
Nhuchhen, D. R.; Sit, S. P.; Layzell, D. B. Decarbonization of Cement Production in a Hydrogen Economy. Appl. Energy 2022, 317, 119180.
Rodríguez, N.; Murillo, R.; Carlos Abanades, J. CO2 Capture from Cement Plants Using Oxyfired Precalcination And/or Calcium Looping. Environmental Science & Technology. 2012, pp 2460-2466. https://doi.org/10.1021/es2030593.
Agency, I. E.; International Energy Agency. Cement Technology Roadmap: Carbon Emissions Reductions up to 2050. IEA Technology Roadmaps. 2009. https://doi.org/10.1787/9789264088061-en.
Steward, D.; Ramsden, T.; Zuboy, J. H2A Central Hydrogen Production Model, Version 3 User Guide. National Renewable Energy Laboratory (NREL) 2012.
Luyben, W. L. Capital Cost of Compressors for Conceptual Design. Chemical Engineering and Processing-Process Intensification 2018, 126, 206-209.
Lena, E. D.; De Lena, E.; Spinelli, M.; Gatti, M.; Scaccabarozzi, R.; Campanari, S.; Consonni, S.; Cinti, G.; Romano, M. C. Techno-Economic Analysis of Calcium Looping Processes for Low CO2 Emission Cement Plants. SSRN Electronic Journal. https://doi.org/10.2139/ssrn.3365845.
International Energy Agency. Tracking Industrial Energy Efficiency and CO2 Emissions; IEA, 2007.
Verma, Y. K.; Mazumdar, B.; Ghosh, P. Thermal Energy Consumption and Its Conservation for a Cement Production Unit. Environmental Engineering Research 2021, 26 (3). https://doi.org/10.4491/eer.2020.111.
Moreno-Soriano, R.; Soriano-Moranchel, F.; Flores-Herrera, L. A.; Sandoval-Pineda, J. M.; González-Huerta, R. de G. Thermal Efficiency of Oxyhydrogen Gas Burner. Energies 2020, 13 (20), 5526.
Carbon intensity of electricity. Our World in Data. https://ourworldindata.org/grapher/carbon-intensity-electricity (Accessed Jul. 12, 2022) (accessed 2022 Jul. 11).
Boesch, M. E.; Hellweg, S. Identifying Improvement Potentials in Cement Production with Life Cycle Assessment. Environ. Sci. Technol. 2010, 44 (23), 9143-9149.
Andrew, R. M. Global CO 2 Emissions from Cement Production. Earth System Science Data 2018, 10 (1), 195-217.
Huntzinger, D. N.; Eatmon, T. D. A Life-Cycle Assessment of Portland Cement Manufacturing: Comparing the Traditional Process with Alternative Technologies. J. Clean. Prod. 2009, 17 (7), 668-675.
Madeddu, S.; Ueckerdt, F.; Pehl, M.; Peterseim, J.; Lord, M.; Kumar, K. A.; Krüger, C.; Luderer, G. The CO2 Reduction Potential for the European Industry via Direct Electrification of Heat Supply (power-to-Heat). Environ. Res. Lett. 2020, 15 (12), 124004.
Lu, X.; Jiang, Z.; Yuan, X.; Wu, Y.; Malpass-Evans, R.; Zhong, Y.; Liang, Y.; Mckeown, N. B.; Wang, H. A Bio-Inspired O2-Tolerant Catalytic CO2 Reduction Electrode. Sci Bull. Fac. Agric. Kyushu Univ. 2019, 64 (24), 1890-1895.
Huang, J. E.; Li, F.; Ozden, A.; Sedighian Rasouli, A.; García de Arquer, F. P.; Liu, S.; Zhang, S.; Luo, M.; Wang, X.; Lum, Y.; Xu, Y.; Bertens, K.; Miao, R. K.; Dinh, C.-T.; Sinton, D.; Sargent, E. H. CO2 Electrolysis to Multicarbon Products in Strong Acid. Science 2021, 372 (6546), 1074-1078.
Zhang, Z.; Lees, E. W.; Ren, S.; Huang, A.; Berlinguette, C. P. Electrolytic Conversion of Bicarbonate Solutions to CO At>500 mA Cm-2 and 2.2 V. ChemRxiv. Prepr. 2021.
Ren, S.; Joulie, D.; Salvatore, D.; Torbensen, K.; Wang, M.; Robert, M.; Berlinguette, C. P. Molecular Electrocatalysts Can Mediate Fast, Selective CO2 Reduction in a Flow Cell. Science 2019, 365 (6451), 367-369.
Kas, R.; Star, A. G.; Yang, K.; Van Cleve, T.; Neyerlin, K. C.; Smith, W. A. Along the Channel Gradients Impact on the Spatioactivity of Gas Diffusion Electrodes at High Conversions during CO₂ Electroreduction. ACS Sustainable Chem. Eng. 2021, 9 (3), 1286-1296.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and.
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5; and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method of producing metal hydroxide from metal carbonate salt in an electrochemical cell, the method comprising:
applying an electrical potential between an anode and a cathode of the electrochemical cell, wherein the electrochemical cell comprises an anode chamber, a cathode chamber, a chemical compartment between the anode chamber and the cathode chamber, a first ion exchange membrane separating the anode chamber and the chemical compartment, and a second ion membrane separating the cathode chamber and the chemical compartment;
oxidizing a first hydrogen-containing reactant, at the anode, to form hydrogen ions;
permeating the hydrogen ions through the first ion exchange membrane into the chemical compartment;
supplying a metal carbonate salt to the chemical compartment;
reacting, at the chemical compartment, the metal carbonate salt with the hydrogen ions to form metal ions;
permeating the metal ions through the second ion exchange membrane into the cathode chamber;
reducing a second hydrogen-containing reactant, at the cathode, to form hydroxide ions; and
removing metal hydroxide formed from reacting the metal ions with the hydroxide ions from the cathode chamber.

2.-4. (canceled)

5. The method as defined in claim 1, wherein the first hydrogen-containing reactant comprises hydrogen gas, and the second hydrogen-containing reactant comprises water.

6. (canceled)

7. The method as defined in claim 1, comprising producing hydrogen gas at the cathode from the reducing of the second hydrogen-containing reactant to form hydroxide ions.

8. The method as defined in claim 1, comprising producing carbon dioxide gas in the chemical compartment from the reacting of the metal carbonate salt with the hydrogen ions to form metal ions.

9. The method as defined in claim 7, further comprising:
discharging the hydrogen gas out of the cathode chamber; and
delivering the hydrogen gas produced at the cathode into the anode chamber.

10.-17. (canceled)

18. The method as defined in claim 1, further comprising suspending the metal carbonate salt in a solvent before supplying the metal carbonate to the chemical compartment.

19. (canceled)

20. A method of producing metal hydroxide from metal carbonate salt in an electrochemical cell, the method comprising:
applying an electrical potential between an anode and a cathode of the electrochemical cell, wherein the electrochemical cell comprises an anode chamber, a cathode chamber, a chemical compartment between the anode chamber and the cathode chamber, a first ion exchange membrane separating the anode chamber and the chemical compartment, and a second ion membrane separating the cathode chamber and the chemical compartment;
oxidizing a first hydrogen-containing reactant, at the anode, to form water;
permeating the water into a bipolar membrane, the bipolar membrane having an anion exchange layer facing the anode and a cation exchange layer facing the chemical compartment;
dissociating, in the bipolar membrane, the water to produce hydrogen ions;
permeating the hydrogen ions through the cation exchange layer into the chemical compartment;
supplying a metal carbonate salt to the chemical compartment;
reacting, at the chemical compartment, the metal carbonate salt with the hydrogen ions to form metal ions;
permeating the metal ions through the second ion exchange membrane into the cathode chamber;
reducing a second hydrogen-containing reactant, at the cathode, to form hydroxide ions; and
removing metal hydroxide formed from reacting the metal ions with the hydroxide ions from the cathode chamber.

21.-22. (canceled)

23. The method as defined in claim 20, wherein the first hydrogen-containing reactant comprises a basean anolyte.

24.-25. (canceled)

26. The method as defined in claim 20, wherein the second hydrogen-containing reactant comprises water.

27. The method as defined in claim 20, comprising producing hydrogen gas at the cathode from the reducing of the second hydrogen-containing reactant to form hydroxide ions.

28. The method as defined in claim 20, comprising producing carbon dioxide gas in the chemical compartment from the reacting of the metal carbonate salt with the hydrogen ions to form metal ions.

29. The method as defined claim 20, comprising producing oxygen gas in the anode chamber from the oxidizing of the first hydrogen-containing reactant to form water.

30.-34. (canceled)

35. The method as defined in claim 20, further comprising suspending the metal carbonate salt in a solvent comprising a salt solution before supplying the metal carbonate to the chemical compartment.

36. (canceled)

37. A method for producing calcium hydroxide from calcium carbonate, the method comprising:
supplying calcium carbonate (CaCO₃) to an electrochemical cell;
applying an electrical potential of 5 Volts or less between an anode and a cathode of the electrochemical cell while maintaining an average current density of at least 100 mA cm⁻²;
at the cathode generating hydroxide ions (OH⁻);
at the anode generating hydrogen ions (H⁺);
in the electrochemical cell, dissociating carbon carbonate into calcium ions (Ca²⁺) and bringing the calcium ions together with the hydroxide ions; and
removing the calcium hydroxide from the electrochemical cell.

38. The method as defined in claim 37, wherein the hydroxide ions are generated from a hydrogen evolution reaction (HER) at the cathode, and
wherein the hydrogen ions are generated from a hydrogen oxidation reaction (HOR) or from an oxygen evolution reaction (OER) at the anode.

39.-40. (canceled)

41. The method as defined in claim 37, further comprising permeating the hydrogen ions through a first membrane into a chemical compartment of the electrochemical cell.

42. The method as defined in claim 37, further comprising permeating the calcium ions through a second membrane into a cathode chamber of the electrochemical cell to bring the calcium ions together with the hydroxide ions, wherein the cathode is arranged within the cathode chamber.

43. The method as defined in claim 41, wherein the first membrane comprises an ion exchange membrane or a bipolar membrane (BPM), and the second membrane comprises an ion exchange membrane.

44.-71. (canceled)

72. A method of producing metal hydroxide from metal carbonate salt in an electrochemical cell, the method comprising:
applying an electrical potential between an anode and a cathode of the electrochemical cell, wherein the electrochemical cell comprises an anode chamber, a cathode chamber, a chemical compartment between the anode chamber and the cathode chamber, a first ion exchange membrane separating the anode chamber and the chemical compartment, and a second ion membrane separating the cathode chamber and the chemical compartment;
oxidizing a first hydrogen-containing reactant, at the anode, to form hydrogen ions;
permeating the hydrogen ions through the first ion exchange membrane into the chemical compartment;
supplying a metal carbonate salt to the chemical compartment;
reacting, at the chemical compartment, the metal carbonate salt with the hydrogen ions to form metal ions;
permeating the metal ions through the second ion exchange membrane into the cathode chamber;
reducing a second hydrogen-containing reactant, at the cathode, to form a reduced reaction product;
supplying a solution comprising hydroxide ions to the cathode chamber; and
removing metal hydroxide formed from reacting the metal ions with the hydroxide ions from the cathode chamber.

73. A method of producing metal hydroxide from metal carbonate salt in an electrochemical cell, the method comprising:
applying an electrical potential between an anode and a cathode of the electrochemical cell, wherein the electrochemical cell comprises an anode chamber, a cathode chamber, a chemical compartment between the anode chamber and the cathode chamber, a first ion exchange membrane separating the anode chamber and the chemical compartment, and a second ion membrane separating the cathode chamber and the chemical compartment;
oxidizing a first hydrogen-containing reactant, at the anode, to form water;
permeating the water into a bipolar membrane, the bipolar membrane having an anion exchange layer facing the anode and a cation exchange layer facing the chemical compartment;
dissociating, in the bipolar membrane, the water to produce hydrogen ions;
permeating the hydrogen ions through the cation exchange layer into the chemical compartment;
supplying a metal carbonate salt to the chemical compartment;
reacting, at the chemical compartment, the metal carbonate salt with the hydrogen ions to form metal ions;
permeating the metal ions through the second ion exchange membrane into the cathode chamber;
reducing a second hydrogen-containing reactant, at the cathode, to form a reduced reaction product;
supplying a solution comprising hydroxide ions to the cathode chamber; and
removing metal hydroxide formed from reacting the metal ions with the hydroxide ions from the cathode chamber.

74. The method as defined in claim 1, further comprising flowing the metal hydroxides out of the cathode chamber at a discharge rate.

75. The method as defined in claim 20, further comprising flowing the metal hydroxides out of the cathode chamber at a discharge rate.
